(19) United States
(12) Patent Application Publication
(10) Pub. No.: US 2021/0029652 A1
(43) Pub. Date: Jan. 28, 2021

(54) INFORMATION TRANSMISSION METHOD, DEVICE, NETWORK DEVICE AND TERMINAL

(71) Applicants: China Mobile Communication Co., Ltd Research Institute, Beijing (CN); China Mobile Communications Group Co.,Ltd., Beijing (CN)

(72) Inventors: Nan LI, Beijing (CN); Xiaoran ZHANG, Beijing (CN); Zhe SHAO, Beijing (CN); Nan HU, Beijing (CN); Guang YANG, Beijing (CN)

(21) Appl. No.: 15/733,708

(22) PCT Filed: Apr. 3, 2019
(86) PCT No.: PCT/CN2019/081248

§ 371 Date: Sep. 30, 2020

(30) Foreign Application Priority Data
Apr. 4, 2018 (CN) 201810302143.6

(51) Int. Cl. H04W 52/36; H04W 72/04

(52) U.S. Cl. CPC H04W 52/365; H04W 72/042; H04W 72/044

(57) ABSTRACT

An information transmission method, a device, a network device and a terminal are provided. The method includes: sending first indication information to a terminal, where the first indication information includes at least one of: location area identity information of the network device, information of current uplink and downlink configuration of the network device, specific absorption ratio limit information, uplink resource control information, and first time window configuration information configured to indicate a duration of a first time window.

### CROSS REFERENCE OF RELATED APPLICATION

The present application claims a priority of Chinese patent application No. 201810302143.6 filed on Apr. 4, 2018, which is incorporated herein by reference in its entirety.

### TECHNICAL FIELD

The present disclosure relates to the field of communications technology, in particular to an information transmission method, a device, a network device and a terminal.

### BACKGROUND

Specific Absorption Ratio (SAR) refers to the electromagnetic radiation energy absorbed by a unit mass of matter per unit time. The SAR value is usually used to measure the thermal effect of terminal radiation internationally, and it also represents the impact of radiation on the human body. The lower the SAR value, the less radiation is absorbed. Each country or region has formulated corresponding mandatory management requirements for the SAR value, and the terminal access detection must comply with it. China, Japan and the European Union adopt the same standards, the SAR limit received per 10 g object is less than 2.0 w/kg; the United States, South Korea, and Australia refer to the IEEE standard, the SAR limit received per 10 g object is less than 1.6 w/kg.

In order to effectively improve the uplink coverage and rate of the network, operators have proposed standardized requirements for high-power terminals in multiple TDD frequency bands (n41, 2496-2690 MHz; n78, 3300-3800 MHz; n79, 4400-5000 MHz). When the transmitting power of the terminal increases, the SAR value of its specific absorption ratio will also increase. It is necessary to formulate reasonable measures to ensure that these high-power terminals in the TDD frequency band meet the requirements of regional SAR values and serve more abundant business types, such as telemedicine/education/monitoring, networked drones, cloud robots and other services that has a requirement of high uplink speed and a requirement of delay.

### SUMMARY

The present disclosure is to provide an information transmission method, a device, a network device and a terminal, so as to solve the issues of conflicts between high-power terminals and SAR values in the related art.

In order to solve the above issues, an information transmission method applied to a network device is provided in an embodiment of the present disclosure, including:

sending first indication information to a terminal, where the first indication information includes at least one of:

location area identity information of the network device;

information of current uplink and downlink configuration of the network device;

specific absorption ratio limit information, including: an applicable electromagnetic power density exposure requirement, an electromagnetic radiation specific absorption ratio requirement limit, an applicable electromagnetic power density exposure requirement identity or an electromagnetic radiation specific absorption ratio requirement limit identity;

uplink resource control information, including at least one of: a quantity of uplink time domain resources, a quantity of uplink symbols, a quantity of uplink slots, an uplink symbol duty ratio, an uplink slot duty ratio, a maximum quantity of available uplink time domain resources of the terminal, a maximum quantity of available uplink symbols of the terminal, a maximum quantity of available uplink slots of the terminal, a maximum available uplink symbol duty ratio of the terminal, a maximum uplink slot duty ratio of the terminal, a maximum quantity of uplink time domain resources capable of being scheduled or transmitted of the terminal, a maximum quantity of uplink symbols capable of being scheduled or transmitted of the terminal, a maximum quantity of uplink slots capable of being scheduled or transmitted of the terminal, a maximum percentage of uplink duration capable of being scheduled or transmitted of the terminal, a maximum percentage of uplink slot capable of being scheduled or transmitted of the terminal, a maximum percentage of uplink sub-frame capable of being scheduled or transmitted of the terminal and a maximum percentage of uplink symbol capable of being scheduled or transmitted of the terminal in the first time window; and

first time window configuration information configured to indicate a duration of a first time window.

Optionally, the sending the first indication information to the terminal includes:

sending the first indication information to the terminal through broadcast information; or

sending the first indication information to the terminal through a dedicated signaling.

Optionally, the sending the first indication information to the terminal includes:

sending the first indication information to the terminal at a first working frequency band where the network device works.

Optionally, the first time window includes at least one frame structure period; or

the first time window includes at least one slot; or

the first time window includes at least one sub-frame; or,

the first time window includes at least one symbol; or

the first time window includes at least one millisecond.

Optionally, the first time window is a predefined evaluation period;

the first time window is a time reference for the terminal to evaluate whether the applicable electromagnetic power density exposure requirement or the electromagnetic radiation specific absorption ratio requirement limit is met; or

the first time window is a time range of a maximum available uplink resource of the terminal in a case that the terminal evaluates that the applicable electromagnetic power density exposure requirement or the electromagnetic radiation specific absorption ratio requirement limit is met; or

the first time window is a time range of a maximum available output power configurable by the terminal in the case that the terminal evaluates that the applicable electromagnetic power density exposure requirement or the electromagnetic radiation specific absorption ratio requirement limit is met.

Optionally, the method further includes: acquiring second indication information reported by the terminal,

where the second indication information includes at least one of:

available uplink and downlink configuration information of the terminal, in a case of ensuring compliance with applicable electromagnetic power density exposure requirement or the electromagnetic radiation specific absorption ratio requirement limit;

in a case of ensuring compliance with applicable electromagnetic power density exposure requirement or the electromagnetic radiation specific absorption ratio requirement limit, at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window;

in a case that the current uplink and downlink configuration of the network device is applied, a maximum available output power configurable by the terminal in a case of ensuring compliance with applicable electromagnetic power density exposure requirement or the electromagnetic radiation specific absorption ratio requirement limit;

first power class information of the terminal at a first working frequency band where the network device works; and

the maximum available output powers configurable by the terminal corresponding to different uplink and downlink configurations, in the case that the applicable electromagnetic power density exposure requirement or the electromagnetic radiation specific absorption ratio requirement limit is met.

Optionally, the method further includes: prior to acquiring the second indication information, acquiring second power class information of the terminal at the first working frequency band where the network device works;

where a transmitting power corresponding to the second power class information is larger than a transmitting power corresponding to the first power class information.

Optionally, the method further includes:

in a case that a current uplink and downlink configuration of the network device is applied, determining a maximum available output power configurable by the terminal in a case of ensuring compliance with applicable electromagnetic power density exposure requirement or the electromagnetic radiation specific absorption ratio requirement limit; or

in the case that the current uplink and downlink configuration of the network device is applied, determining at least one of a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal; or

determining first power class information of the terminal at a first working frequency band where the network device works; or

determining a maximum available output power configurable by the terminal in the first time window; or

determining at least one of a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window.

Optionally, the method further includes:

determining the maximum available output power configurable by the terminal in the first time window, according to the second indication information reported by the terminal; or

determining the first power class information of the terminal at a first working frequency band where the network device works, according to the second indication information reported by the terminal; or

determining, according to the second indication information reported by the terminal, at least one of the maximum uplink duration capable of being scheduled or transmitted of the terminal, the maximum quantity of uplink slots capable of being scheduled or transmitted of the terminal, the maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window.

Optionally, the method further includes:

the network device performing an uplink resource scheduling or uplink transmission for the terminal;

where a duration of scheduled or transmitted resource is less than or equal to a maximum uplink duration capable of being scheduled or transmitted of the terminal; or

a quantity of slots of the scheduled or transmitted resource is less than or equal to a maximum quantity of uplink slots capable of being scheduled or transmitted of the terminal; or

a quantity of uplink sub-frames of the scheduled or transmitted resource is less than or equal to a maximum quantity of uplink sub-frames capable of being scheduled or transmitted of the terminal; or

a quantity of uplink symbols of the scheduled or transmitted resource is less than or equal to a maximum quantity of uplink symbols capable of being scheduled or transmitted of the terminal; or

an uplink duration percentage of the scheduled or transmitted resource is less than or equal to a maximum percentage of uplink duration capable of being scheduled or transmitted of the terminal; or

an uplink slot percentage of the scheduled or transmitted resource is less than or equal to a maximum percentage of uplink slot capable of being scheduled or transmitted of the terminal; or

an uplink sub-frame percentage of the scheduled or transmitted resource is less than or equal to a maximum percentage of uplink sub-frame capable of being scheduled or transmitted of the terminal; or

an uplink symbol percentage of the scheduled or transmitted resource is less than or equal to a maximum percentage of uplink symbol capable of being scheduled or transmitted of the terminal.

Optionally, the method further includes:

sending, by the network device, a power adjustment value to the terminal; where

in a case that the power adjustment value is applied to the terminal, a transmitting power of the terminal is less than or equal to a maximum available output power configurable by the terminal; or

in the case that the power adjustment value is applied to the terminal, the transmitting power of the terminal is less than or equal to a transmitting power value corresponding to a first power class of the terminal at a first working frequency band; or

in the case that the power adjustment value is applied to the terminal, the transmitting power of the terminal is less than or equal to the maximum available output power configurable by the terminal in a case that the current uplink and downlink configuration of the network device is applied.

An information transmission method applied to a terminal is further provided in an embodiment of the present disclosure, including:

receiving first indication information sent by a network device, where the first indication information includes at least one of:

location area identity information of the network device;

information of current uplink and downlink configuration of the network device;

specific absorption ratio limit information, including: an applicable electromagnetic power density exposure requirement, an electromagnetic radiation specific absorption ratio requirement limit, an applicable electromagnetic power density exposure requirement identity or an electromagnetic radiation specific absorption ratio requirement limit identity;

uplink resource control information, including at least one of: a quantity of uplink time domain resources, a quantity of uplink symbols, a quantity of uplink slots, an uplink symbol duty ratio, an uplink slot duty ratio, a maximum quantity of available uplink time domain resources of the terminal, a maximum quantity of available uplink symbols of the terminal, a maximum quantity of available uplink slots of the terminal, a maximum available uplink symbol duty ratio of the terminal, a maximum uplink slot duty ratio of the terminal, a maximum quantity of uplink time domain resources capable of being scheduled or transmitted of the terminal, a maximum quantity of uplink symbols capable of being scheduled or transmitted of the terminal, a maximum quantity of uplink slots capable of being scheduled or transmitted of the terminal, a maximum percentage of uplink duration capable of being scheduled or transmitted of the terminal, a maximum percentage of uplink slot capable of being scheduled or transmitted of the terminal, a maximum percentage of uplink sub-frame capable of being scheduled or transmitted of the terminal and a maximum percentage of uplink symbol capable of being scheduled or transmitted of the terminal in the first time window; and

first time window configuration information configured to indicate a duration of a first time window.

Optionally, the receiving the first indication information sent by the network device includes:

receiving the first indication information of the network device sent by the network device through broadcast information; or

receiving the first indication information of the network device sent by the network device through a dedicated signaling.

Optionally, the receiving the first indication information sent by the network device includes:

receiving the first indication information which is sent by the network device at a first working frequency band where the network device works.

Optionally, the first time window includes at least one frame structure period; or

the first time window includes at least one slot; or

the first time window includes at least one sub-frame; or,

the first time window includes at least one symbol; or

the first time window includes at least one millisecond.

Optionally, the first time window is a predefined evaluation period;

the first time window is a time range for the terminal to evaluate whether the applicable electromagnetic power density exposure requirement or the electromagnetic radiation specific absorption ratio requirement limit is met; or

the first time window is a time range of a maximum available uplink resource of the terminal in a case that the terminal evaluates that the applicable electromagnetic power density exposure requirement or the electromagnetic radiation specific absorption ratio requirement limit is met; or

the first time window is a time range of a maximum available output power configurable by the terminal in the case that the terminal evaluates that the applicable electromagnetic power density exposure requirement or the electromagnetic radiation specific absorption ratio requirement limit is met.

Optionally, the method further includes:

reporting second indication information to the network device,

where the second indication information includes at least one of:

available uplink and downlink configuration information of the terminal, in a case of ensuring compliance with applicable electromagnetic power density exposure requirement or the electromagnetic radiation specific absorption ratio requirement limit;

at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window;

in a case that the current uplink and downlink configuration of the network device is applied, a maximum available output power configurable by the terminal in a case of ensuring compliance with applicable electromagnetic power density exposure requirement or the electromagnetic radiation specific absorption ratio requirement limit;

first power class information of the terminal at a first working frequency band where the network device works; and

maximum available output powers configurable by the terminal corresponding to different uplink and downlink configurations, in the case that the applicable electromagnetic power density exposure requirement or the electromagnetic radiation specific absorption ratio requirement limit is met.

Optionally, the method further includes:

prior to reporting the second indication information to the network device, sending, to the network device, second power class information of the terminal at the first working frequency band where the network device works;

where a transmitting power corresponding to the second power class information is larger than a transmitting power corresponding to the first power class information.

Optionally, in a case that the first indication information includes the location area identity information of the network device, the method further includes:

determining, according to a country identity in the location area identity information of the network device, a country where the network device is located, and acquiring the applicable electromagnetic power density exposure requirement or the electromagnetic radiation specific absorption ratio requirement limit corresponding to the country; or

determining, according to a country identity and an operator identity in the location area identity information of the network device, a country and an operator where the network device is located, and acquiring the applicable electromagnetic power density exposure requirement or the electromagnetic radiation specific absorption ratio requirement limit corresponding to the country and the operator.

Optionally, the reporting the second indication information to the network device includes:

in a case that a second power class of the terminal at the first working frequency band where the network device works does not meet the applicable electromagnetic power density exposure requirement or the electromagnetic radiation specific absorption ratio requirement limit, sending the second indication information to the network device; or

in a case that the terminal with the current uplink and downlink configuration of the network device does not meet the applicable electromagnetic power density exposure requirement or the electromagnetic radiation specific absorption ratio requirement limit, sending the second indication information to the network device; or

in a case that a duration of scheduled or transmitted resource of the terminal is greater than the maximum uplink duration capable of being scheduled or transmitted of the terminal in the first time window, sending the second indication information to the network device; or

in a case that a quantity of slots of scheduled or transmitted resource of the terminal is greater than the maximum quantity of uplink slots capable of being scheduled or transmitted of the terminal in the first time window, sending the second indication information to the network device; or

in a case that a quantity of uplink sub-frames of scheduled or transmitted resource of the terminal is greater than the maximum quantity of uplink sub-frames capable of being scheduled or transmitted of the terminal in the first time window, sending the second indication information to the network device; or

in a case that a quantity of uplink symbols of scheduled or transmitted resource of the terminal is greater than the maximum quantity of uplink symbols capable of being scheduled or transmitted of the terminal in the first time window, sending the second indication information to the network device; or

in a case that an uplink duration percentage of scheduled or transmitted resource of the terminal is greater than the maximum percentage of uplink duration capable of being scheduled or transmitted of the terminal in the first time window, sending the second indication information to the network device; or

in a case that an uplink slot percentage of scheduled or transmitted resource of the terminal is greater than the maximum percentage of uplink slot capable of being scheduled or transmitted of the terminal in the first time window, sending the second indication information to the network device; or

in a case that an uplink sub-frame percentage of scheduled or transmitted resource of the terminal is greater than the maximum percentage of uplink sub-frame capable of being scheduled or transmitted of the terminal in the first time window, sending the second indication information to the network device; or

in a case that an uplink symbol percentage of scheduled or transmitted resource of the terminal is greater than the maximum percentage of uplink symbol capable of being scheduled or transmitted of the terminal in the first time window, sending the second indication information to the network device; or

sending the second indication information to the network device according to the specific absorption ratio limit information.

Optionally, the method further includes:

determining, according to the first indication information, at least one of:

in a case of ensuring compliance with applicable electromagnetic power density exposure requirement or the electromagnetic radiation specific absorption ratio requirement limit, at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal;

in a case that the current uplink and downlink configuration of the network device is applied, a maximum available output power configurable by the terminal in a case of ensuring compliance with applicable electromagnetic power density exposure requirement or the electromagnetic radiation specific absorption ratio requirement limit; and

the maximum available output powers configurable by the terminal in different uplink and downlink configurations, in the case that the applicable electromagnetic power density exposure requirement or the electromagnetic radiation specific absorption ratio requirement limit is met.

Optionally, the method further includes:

reconfiguring a maximum available output power of the terminal, or controlling the terminal to perform a power back-off, or prohibiting a transmission of at least one piece of uplink information of the terminal; where the uplink information includes: an uplink slot, or an uplink sub-frame, or an uplink symbol.

Optionally, controlling the terminal to perform the power back-off includes:

determining the maximum available output power configurable by the terminal according to the first indication information, or determining the maximum available output power configurable by the terminal in a case that the current uplink and downlink configuration of the network device is applied;

in a case that a power of the terminal configured by a network device power control is greater than the maximum available output power configurable by the terminal, performing the power back-off, and controlling the power of the control terminal to back to be less than or equal to the maximum available output power configurable by the terminal.

Optionally, a back-off value of the power back-off is equal to the power configured for the terminal by the network device minus the maximum available output power configurable by the terminal.

Optionally, the prohibiting the transmission of the at least one piece of uplink information of the terminal includes:

in a case of ensuring compliance with applicable electromagnetic power density exposure requirement or the electromagnetic radiation specific absorption ratio requirement limit, determining, according to the first indication information, at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal;

in a case that an uplink duration scheduled by the network device for the terminal is greater than the maximum uplink duration capable of being scheduled or transmitted of the terminal or in a case that an uplink duration percentage scheduled by the network device for the terminal is greater than the maximum percentage of uplink duration capable of being scheduled or transmitted of the terminal, prohibiting a data transmission on at least one uplink time unit; or

in a case that a resource quantity of uplink slots scheduled by the network device for the terminal is greater than a maximum resource quantity of uplink slots capable of being scheduled or transmitted of the terminal or in a case that an uplink slot percentage scheduled by the network device for the terminal is greater than the maximum percentage of uplink slot capable of being scheduled or transmitted of the terminal, prohibiting a data transmission on a resource of at least one uplink slot; or

in a case that a resource quantity of uplink sub-frames scheduled by the network device for the terminal is greater than the maximum quantity of uplink sub-frames capable of being scheduled or transmitted of the terminal or in a case that an uplink sub-frame percentage scheduled by the network device for the terminal is greater than the maximum percentage of uplink sub-frame capable of being scheduled or transmitted of the terminal, prohibiting a data transmission on a resource of at least one uplink sub-frame; or

in a case that a resource quantity of uplink symbols scheduled by the network device for the terminal is greater than the maximum quantity of uplink symbols capable of being scheduled or transmitted of the terminal or in a case that an uplink symbol percentage scheduled by the network device for the terminal is greater than the maximum percentage of uplink symbol capable of being scheduled or transmitted of the terminal, prohibiting a data transmission on a resource of at least one uplink symbol.

Optionally, the method further includes:

in a case that a duration of scheduled or transmitted resource of the terminal is greater than the maximum uplink duration capable of being scheduled or transmitted of the terminal in the first time window, reconfiguring, by the terminal, a maximum available output power of the terminal or performing a power back-off by the terminal; or

in a case that a quantity of slots of scheduled or transmitted resource of the terminal is greater than the maximum quantity of uplink slots capable of being scheduled or transmitted of the terminal in the first time window, reconfiguring, by the terminal, a maximum available output power of the terminal or performing a power back-off by the terminal; or

in a case that a quantity of uplink sub-frames of scheduled or transmitted resource of the terminal is greater than the maximum quantity of uplink sub-frames capable of being scheduled or transmitted of the terminal in the first time window, reconfiguring, by the terminal, a maximum available output power of the terminal or performing a power back-off by the terminal; or

in a case that a quantity of uplink symbols of scheduled or transmitted resource of the terminal is greater than the maximum quantity of uplink symbols capable of being scheduled or transmitted of the terminal in the first time window, reconfiguring, by the terminal, a maximum available output power of the terminal or performing a power back-off by the terminal; or

in a case that an uplink duration percentage of scheduled or transmitted resource of the terminal is greater than the maximum percentage of uplink duration capable of being scheduled or transmitted of the terminal in the first time window, reconfiguring, by the terminal, a maximum available output power of the terminal or performing a power back-off by the terminal; or

in a case that an uplink slot percentage of scheduled or transmitted resource of the terminal is greater than the maximum percentage of uplink slot capable of being scheduled or transmitted of the terminal in the first time window, reconfiguring, by the terminal, a maximum available output power of the terminal or performing a power back-off by the terminal; or

in a case that an uplink sub-frame percentage of scheduled or transmitted resource of the terminal is greater than the maximum percentage of uplink sub-frame capable of being scheduled or transmitted of the terminal in the first time window, reconfiguring, by the terminal, a maximum available output power of the terminal or performing a power back-off by the terminal; or

in a case that an uplink symbol percentage of scheduled or transmitted resource of the terminal is greater than the maximum percentage of uplink symbol capable of being scheduled or transmitted of the terminal in the first time window, reconfiguring, by the terminal, a maximum available output power of the terminal or performing a power back-off by the terminal.

Optionally, one or more of the maximum uplink duration capable of being scheduled or transmitted of the terminal, the maximum quantity of uplink slots capable of being scheduled or transmitted of the terminal, the maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal is determined by the terminal according to uplink resource control information in the first indication information; or

one or more of the maximum uplink duration capable of being scheduled or transmitted of the terminal, the maximum quantity of uplink slots capable of being scheduled or transmitted of the terminal, the maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal is predefined in a criterion.

Optionally, the method further includes:

reporting a reconfigured maximum available output power of the terminal to the network device; or

in a case that scheduled uplink resource of the terminal in the first time window exceeds a first threshold, after the terminal performs the power back-off, a power value of the terminal is less than or equal to a maximum available output power configurable by the terminal.

Optionally, the method further includes:

in a case that an uplink symbol percentage scheduled or transmitted by the terminal in the first time window is greater than a capability of the terminal corresponding to the second indication information, applying all requirements for the first power class to the supported power class.

Optionally, the method further includes:

in a case that an uplink symbol percentage scheduled or transmitted by the terminal in the first time window is greater than a capability of the terminal corresponding to the second indication information, lowering a lower limit of a maximum transmitting power configuration value of the terminal.

An information transmission method applied to a terminal is further provided in an embodiment of the present disclosure, including: sending second indication information to a network device,

where the second indication information includes at least one of:

available uplink and downlink configuration information of the terminal, in a case of ensuring compliance with applicable electromagnetic power density exposure requirement or the electromagnetic radiation specific absorption ratio requirement limit;

in a case of ensuring compliance with applicable electromagnetic power density exposure requirement or the electromagnetic radiation specific absorption ratio requirement limit, at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window;

in a case that the current uplink and downlink configuration of the network device is applied, a maximum available output power configurable by the terminal in a case of ensuring compliance with applicable electromagnetic power density exposure requirement or the electromagnetic radiation specific absorption ratio requirement limit;

first power class information of the terminal at a first working frequency band where the network device works; and

the maximum available output powers configurable by the terminal corresponding to different uplink and downlink configurations, in the case that the applicable electromagnetic power density exposure requirement or the electromagnetic radiation specific absorption ratio requirement limit is met.

Optionally, the first time window includes at least one frame structure period; or

the first time window includes at least one slot; or

the first time window includes at least one sub-frame; or,

the first time window includes at least one symbol; or

the first time window includes at least one millisecond.

Optionally, the first time window is a predefined evaluation period;

the first time window is a time range for the terminal to evaluate whether the applicable electromagnetic power density exposure requirement or the electromagnetic radiation specific absorption ratio requirement limit is met; or

the first time window is a time range of a maximum available uplink resource of the terminal in a case that the terminal evaluates that the applicable electromagnetic power density exposure requirement or the electromagnetic radiation specific absorption ratio requirement limit is met; or

the first time window is a time range of a maximum available output power configurable by the terminal in the case that the terminal evaluates that the applicable electromagnetic power density exposure requirement or the electromagnetic radiation specific absorption ratio requirement limit is met.

Optionally, the method further includes:

prior to sending the second indication information to the network device, sending, to the network device, second power class information of the terminal at the first working frequency band where the network device works;

where a transmitting power corresponding to the second power class information is larger than a transmitting power corresponding to the first power class information.

Optionally, the sending to the network device the second power class information of the terminal at the first working frequency band where the network device works includes:

in a case that the current uplink and downlink configuration of the network device is applied and the terminal determines that the applicable electromagnetic power density exposure requirement or the electromagnetic radiation specific absorption ratio requirement limit is not met, sending, to the network device, the second power class information of the terminal at the first working frequency band where the network device works.

Optionally, the method further includes: reporting a power headroom by the terminal, where the power headroom is based on the maximum available output power configurable by the terminal in a case of ensuring compliance with applicable electromagnetic power density exposure requirement or the electromagnetic radiation specific absorption ratio requirement limit.

Optionally, the method further includes:

in a case that an uplink symbol percentage scheduled or transmitted by the terminal in the first time window is greater than a capability of the terminal corresponding to the second indication information, applying all requirements for the first power class to the supported power class.

Optionally, the method further includes:

in a case that an uplink symbol percentage scheduled or transmitted by the terminal in the first time window is greater than a capability of the terminal corresponding to the second indication information, lowering a lower limit of a maximum transmitting power configuration value of the terminal.

An information transmission method applied to a network device is further provided in an embodiment of the present disclosure, including:

receiving second indication information sent by a terminal,

where the second indication information includes at least one of:

available uplink and downlink configuration information of the terminal, in a case of ensuring compliance with applicable electromagnetic power density exposure requirement or the electromagnetic radiation specific absorption ratio requirement limit;

in a case of ensuring compliance with applicable electromagnetic power density exposure requirement or the electromagnetic radiation specific absorption ratio requirement limit, at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window;

in a case that the current uplink and downlink configuration of the network device is applied, a maximum available output power configurable by the terminal in a case of ensuring compliance with applicable electromagnetic power density exposure requirement or the electromagnetic radiation specific absorption ratio requirement limit;

first power class information of the terminal at a first working frequency band where the network device works; and

the maximum available output powers configurable by the terminal corresponding to different uplink and downlink configurations, in the case that the applicable electromagnetic power density exposure requirement or the electromagnetic radiation specific absorption ratio requirement limit is met.

Optionally, the first time window includes at least one frame structure period; or

the first time window includes at least one slot; or

the first time window includes at least one sub-frame; or,

the first time window includes at least one symbol; or

the first time window includes at least one millisecond.

Optionally, the first time window is a predefined evaluation period;

the first time window is a time range for the terminal to evaluate whether the applicable electromagnetic power density exposure requirement or the electromagnetic radiation specific absorption ratio requirement limit is met; or

the first time window is a time range of a maximum available uplink resource of the terminal in a case that the terminal evaluates that the applicable electromagnetic power density exposure requirement or the electromagnetic radiation specific absorption ratio requirement limit is met; or

the first time window is a time range of a maximum available output power configurable by the terminal in the case that the terminal evaluates that the applicable electromagnetic power density exposure requirement or the electromagnetic radiation specific absorption ratio requirement limit is met.

Optionally, the method further includes:

prior to receiving the second indication information sent by the terminal, receiving second power class information of the terminal at the first working frequency band where the network device works which is sent by the terminal;

where a transmitting power corresponding to the second power class information is larger than a transmitting power corresponding to the first power class information.

Optionally, the receiving the second power class information of the terminal at the first working frequency band where the network device works which is sent by the terminal includes:

in a case that the current uplink and downlink configuration of the network device is applied and the terminal determines that the applicable electromagnetic power density exposure requirement or the electromagnetic radiation specific absorption ratio requirement limit is not met, receiving the second power class information of the terminal at the first working frequency band where the network device works which is sent by the terminal.

Optionally, the method further includes: receiving a power headroom reported by the terminal, where the power headroom is based on the maximum available output power configurable by the terminal in a case of ensuring compliance with applicable electromagnetic power density exposure requirement or the electromagnetic radiation specific absorption ratio requirement limit.

Optionally, the method further includes:

the network device performing an uplink resource scheduling or an uplink transmission for the terminal;

a duration of scheduled or transmitted resource is less than or equal to the maximum uplink duration capable of being scheduled or transmitted of the terminal in the first time window; or

a quantity of slots of scheduled or transmitted resource is less than or equal to the maximum quantity of uplink slots capable of being scheduled or transmitted of the terminal in the first time window; or

a quantity of uplink sub-frames of scheduled or transmitted resource is less than or equal to the maximum quantity of uplink sub-frames capable of being scheduled or transmitted of the terminal in the first time window; or

a quantity of uplink symbols of scheduled or transmitted resource is less than or equal to the maximum quantity of uplink symbols capable of being scheduled or transmitted of the terminal in the first time window; or

an uplink duration percentage of scheduled or transmitted resource is less than or equal to the maximum percentage of uplink duration capable of being scheduled or transmitted of the terminal in the first time window; or

an uplink slot percentage of scheduled or transmitted resource is less than or equal to the maximum percentage of uplink slot capable of being scheduled or transmitted of the terminal in the first time window; or

an uplink sub-frame percentage of scheduled or transmitted resource is less than or equal to the maximum percentage of uplink sub-frame capable of being scheduled or transmitted of the terminal in the first time window; or

an uplink symbol percentage of scheduled or transmitted resource is less than or equal to the maximum percentage of uplink symbol capable of being scheduled or transmitted of the terminal in the first time window.

Optionally, the method further includes:

sending, by the network device, a power adjustment value to the terminal; where

in a case that the power adjustment value is applied to the terminal, a transmitting power of the terminal is less than or equal to a maximum available output power configurable by the terminal; or

in the case that the power adjustment value is applied to the terminal, the transmitting power of the terminal is less than or equal to a transmitting power value corresponding to a first power class of the terminal at a first working frequency band; or

in the case that the power adjustment value is applied to the terminal, the transmitting power of the terminal is less than or equal to the maximum available output power configurable by the terminal in a case that the current uplink and downlink configuration of the network device is applied.

A network device is further provided in an embodiment of the present disclosure, including a processor and a transceiver, where the processor is configured to control the transceiver to:

send first indication information to a terminal, where the first indication information includes at least one of:

location area identity information of the network device;

information of current uplink and downlink configuration of the network device;

specific absorption ratio limit information, including: an applicable electromagnetic power density exposure requirement, an electromagnetic radiation specific absorption ratio requirement limit, an applicable electromagnetic power density exposure requirement identity or an electromagnetic radiation specific absorption ratio requirement limit identity;

uplink resource control information, including at least one of: a quantity of uplink time domain resources, a quantity of uplink symbols, a quantity of uplink slots, an uplink symbol duty ratio, an uplink slot duty ratio, a maximum quantity of available uplink time domain resources of the terminal, a maximum quantity of available uplink symbols of the terminal, a maximum quantity of available uplink slots of the terminal, a maximum available uplink symbol duty ratio of the terminal, a maximum uplink slot duty ratio of the terminal, a maximum quantity of uplink time domain resources capable of being scheduled or transmitted of the terminal, a maximum quantity of uplink symbols capable of being scheduled or transmitted of the terminal, a maximum quantity of uplink slots capable of being scheduled or transmitted of the terminal, a maximum percentage of uplink duration capable of being scheduled or transmitted of the terminal, a maximum percentage of uplink slot capable of being scheduled or transmitted of the terminal, a maximum percentage of uplink sub-frame capable of being scheduled or transmitted of the terminal and a maximum percentage of uplink symbol capable of being scheduled or transmitted of the terminal in the first time window; and

first time window configuration information configured to indicate a duration of a first time window.

Optionally, the transceiver is further configured to:

send the first indication information to the terminal through broadcast information; or

send the first indication information to the terminal through a dedicated signaling.

Optionally, the transceiver is further configured to:

send the first indication information to the terminal at a first working frequency band where the network device works.

Optionally, the first time window includes at least one frame structure period; or

the first time window includes at least one slot; or

the first time window includes at least one sub-frame; or,

the first time window includes at least one symbol; or

the first time window includes at least one millisecond.

Optionally, the first time window is a predefined evaluation period;

the first time window is a time reference for the terminal to evaluate whether the applicable electromagnetic power density exposure requirement or the electromagnetic radiation specific absorption ratio requirement limit is met; or

the first time window is a time range of a maximum available uplink resource of the terminal in a case that the terminal evaluates that the applicable electromagnetic power density exposure requirement or the electromagnetic radiation specific absorption ratio requirement limit is met; or

the first time window is a time range of a maximum available output power configurable by the terminal in the case that the terminal evaluates that the applicable electromagnetic power density exposure requirement or the electromagnetic radiation specific absorption ratio requirement limit is met.

Optionally, the transceiver is further configured to acquire second indication information reported by the terminal,

where the second indication information includes at least one of:

available uplink and downlink configuration information of the terminal, in a case of ensuring compliance with applicable electromagnetic power density exposure requirement or the electromagnetic radiation specific absorption ratio requirement limit;

in a case of ensuring compliance with applicable electromagnetic power density exposure requirement or the electromagnetic radiation specific absorption ratio requirement limit, at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window;

in a case that the current uplink and downlink configuration of the network device is applied, a maximum available output power configurable by the terminal in a case of ensuring compliance with applicable electromagnetic power density exposure requirement or the electromagnetic radiation specific absorption ratio requirement limit;

first power class information of the terminal at a first working frequency band where the network device works; and

the maximum available output powers configurable by the terminal corresponding to different uplink and downlink configurations, in the case that the applicable electromagnetic power density exposure requirement or the electromagnetic radiation specific absorption ratio requirement limit is met.

Optionally, the transceiver is further configured to: prior to acquiring the second indication information, acquire second power class information of the terminal at the first working frequency band where the network device works;

where a transmitting power corresponding to the second power class information is larger than a transmitting power corresponding to the first power class information.

Optionally, the processor is further configured to:

in a case that a current uplink and downlink configuration of the network device is applied, determine a maximum available output power configurable by the terminal in a case of ensuring compliance with applicable electromagnetic power density exposure requirement or the electromagnetic radiation specific absorption ratio requirement limit; or

in the case that the current uplink and downlink configuration of the network device is applied, determine at least one of a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal; or

determine first power class information of the terminal at a first working frequency band where the network device works; or

determine a maximum available output power configurable by the terminal in the first time window; or

determine at least one of a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window.

Optionally, the processor is further configured to:

determine the maximum available output power configurable by the terminal in the first time window, according to the second indication information reported by the terminal; or

determine the first power class information of the terminal at a first working frequency band where the network device works, according to the second indication information reported by the terminal; or

determine, according to the second indication information reported by the terminal, at least one of the maximum uplink duration capable of being scheduled or transmitted of the terminal, the maximum quantity of uplink slots capable of being scheduled or transmitted of the terminal, the maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window.

Optionally, the processor is further configured to:

perform an uplink resource scheduling or uplink transmission for the terminal;

where a duration of scheduled or transmitted resource is less than or equal to a maximum uplink duration capable of being scheduled or transmitted of the terminal; or

a quantity of slots of the scheduled or transmitted resource is less than or equal to a maximum quantity of uplink slots capable of being scheduled or transmitted of the terminal; or

a quantity of uplink sub-frames of the scheduled or transmitted resource is less than or equal to a maximum quantity of uplink sub-frames capable of being scheduled or transmitted of the terminal; or

a quantity of uplink symbols of the scheduled or transmitted resource is less than or equal to a maximum quantity of uplink symbols capable of being scheduled or transmitted of the terminal; or

an uplink duration percentage of the scheduled or transmitted resource is less than or equal to a maximum percentage of uplink duration capable of being scheduled or transmitted of the terminal; or

an uplink slot percentage of the scheduled or transmitted resource is less than or equal to a maximum percentage of uplink slot capable of being scheduled or transmitted of the terminal; or

an uplink sub-frame percentage of the scheduled or transmitted resource is less than or equal to a maximum percentage of uplink sub-frame capable of being scheduled or transmitted of the terminal; or

an uplink symbol percentage of the scheduled or transmitted resource is less than or equal to a maximum percentage of uplink symbol capable of being scheduled or transmitted of the terminal.

Optionally, the processor is further configured to:

send a power adjustment value to the terminal; where

in a case that the power adjustment value is applied to the terminal, a transmitting power of the terminal is less than or equal to a maximum available output power configurable by the terminal; or

in the case that the power adjustment value is applied to the terminal, the transmitting power of the terminal is less than or equal to a transmitting power value corresponding to a first power class of the terminal at a first working frequency band; or

in the case that the power adjustment value is applied to the terminal, the transmitting power of the terminal is less than or equal to the maximum available output power configurable by the terminal in a case that the current uplink and downlink configuration of the network device is applied.

An information transmission device is further provided in an embodiment of the present disclosure, applied to a network device, including:

a first sending module, configured to send first indication information to a terminal, where the first indication information includes at least one of:

location area identity information of the network device;

information of current uplink and downlink configuration of the network device;

specific absorption ratio limit information, including: an applicable electromagnetic power density exposure requirement, an electromagnetic radiation specific absorption ratio requirement limit, an applicable electromagnetic power density exposure requirement identity or an electromagnetic radiation specific absorption ratio requirement limit identity;

uplink resource control information, including at least one of: a quantity of uplink time domain resources, a quantity of uplink symbols, a quantity of uplink slots, an uplink symbol duty ratio, an uplink slot duty ratio, a maximum quantity of available uplink time domain resources of the terminal, a maximum quantity of available uplink symbols of the terminal, a maximum quantity of available uplink slots of the terminal, a maximum available uplink symbol duty ratio of the terminal, a maximum uplink slot duty ratio of the terminal, a maximum quantity of uplink time domain resources capable of being scheduled or transmitted of the terminal, a maximum quantity of uplink symbols capable of being scheduled or transmitted of the terminal, a maximum quantity of uplink slots capable of being scheduled or transmitted of the terminal, a maximum percentage of uplink duration capable of being scheduled or transmitted of the terminal, a maximum percentage of uplink slot capable of being scheduled or transmitted of the terminal, a maximum percentage of uplink sub-frame capable of being scheduled or transmitted of the terminal and a maximum percentage of uplink symbol capable of being scheduled or transmitted of the terminal in the first time window; and

first time window configuration information configured to indicate a duration of a first time window.

A terminal is further provided in an embodiment of the present disclosure, including a processor and a transceiver, where the processor is configured to control the transceiver to:

receive first indication information sent by a network device, where the first indication information includes at least one of:

location area identity information of the network device;

information of current uplink and downlink configuration of the network device;

specific absorption ratio limit information, including: an applicable electromagnetic power density exposure requirement, an electromagnetic radiation specific absorption ratio requirement limit, an applicable electromagnetic power density exposure requirement identity or an electromagnetic radiation specific absorption ratio requirement limit identity;

uplink resource control information, including at least one of: a quantity of uplink time domain resources, a quantity of uplink symbols, a quantity of uplink slots, an uplink symbol duty ratio, an uplink slot duty ratio, a maximum quantity of available uplink time domain resources of the terminal, a maximum quantity of available uplink symbols of the terminal, a maximum quantity of available uplink slots of the terminal, a maximum available uplink symbol duty ratio of the terminal, a maximum uplink slot duty ratio of the terminal, a maximum quantity of uplink time domain resources capable of being scheduled or transmitted of the terminal, a maximum quantity of uplink symbols capable of being scheduled or transmitted of the terminal, a maximum quantity of uplink slots capable of being scheduled or transmitted of the terminal, a maximum percentage of uplink duration capable of being scheduled or transmitted of the terminal, a maximum percentage of uplink slot capable of being scheduled or transmitted of the terminal, a maximum percentage of uplink sub-frame capable of being scheduled or transmitted of the terminal and a maximum percentage of uplink symbol capable of being scheduled or transmitted of the terminal in the first time window; and

first time window configuration information configured to indicate a duration of a first time window.

Optionally, the transceiver is further configured to:

receive the first indication information of the network device sent by the network device through broadcast information; or

receive the first indication information of the network device sent by the network device through a dedicated signaling.

Optionally, the transceiver is further configured to:

receive the first indication information which is sent by the network device at a first working frequency band where the network device works.

Optionally, the first time window includes at least one frame structure period; or

the first time window includes at least one slot; or

the first time window includes at least one sub-frame; or,

the first time window includes at least one symbol; or

the first time window includes at least one millisecond.

Optionally, the first time window is a predefined evaluation period;

the first time window is a time range for the terminal to evaluate whether the applicable electromagnetic power density exposure requirement or the electromagnetic radiation specific absorption ratio requirement limit is met; or

the first time window is a time range of a maximum available uplink resource of the terminal in a case that the terminal evaluates that the applicable electromagnetic power density exposure requirement or the electromagnetic radiation specific absorption ratio requirement limit is met; or

the first time window is a time range of a maximum available output power configurable by the terminal in the case that the terminal evaluates that the applicable electromagnetic power density exposure requirement or the electromagnetic radiation specific absorption ratio requirement limit is met.

Optionally, the processor is further configured to:

control the transceiver to report second indication information to the network device,

where the second indication information includes at least one of:

available uplink and downlink configuration information of the terminal, in a case of ensuring compliance with applicable electromagnetic power density exposure requirement or the electromagnetic radiation specific absorption ratio requirement limit;

at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window;

in a case that the current uplink and downlink configuration of the network device is applied, a maximum available output power configurable by the terminal in a case of ensuring compliance with applicable electromagnetic power density exposure requirement or the electromagnetic radiation specific absorption ratio requirement limit;

first power class information of the terminal at a first working frequency band where the network device works; and

maximum available output powers configurable by the terminal corresponding to different uplink and downlink configurations, in the case that the applicable electromagnetic power density exposure requirement or the electromagnetic radiation specific absorption ratio requirement limit is met.

Optionally, the transceiver is further configured to:

prior to reporting the second indication information to the network device, send, to the network device, second power class information of the terminal at the first working frequency band where the network device works;

where a transmitting power corresponding to the second power class information is larger than a transmitting power corresponding to the first power class information.

Optionally, in a case that the first indication information includes the location area identity information of the network device, the processor is further configured to:

determine, according to a country identity in the location area identity information of the network device, a country where the network device is located, and acquire the applicable electromagnetic power density exposure requirement or the electromagnetic radiation specific absorption ratio requirement limit corresponding to the country; or

determine, according to a country identity and an operator identity in the location area identity information of the network device, a country and an operator where the network device is located, and acquire the applicable electromagnetic power density exposure requirement or the electromagnetic radiation specific absorption ratio requirement limit corresponding to the country and the operator.

Optionally, the transceiver is further configured to:

in a case that a second power class of the terminal at the first working frequency band where the network device works does not meet the applicable electromagnetic power density exposure requirement or the electromagnetic radiation specific absorption ratio requirement limit, send the second indication information to the network device; or

in a case that the terminal with the current uplink and downlink configuration of the network device does not meet the applicable electromagnetic power density exposure requirement or the electromagnetic radiation specific absorption ratio requirement limit, send the second indication information to the network device; or

in a case that a duration of scheduled or transmitted resource of the terminal is greater than the maximum uplink duration capable of being scheduled or transmitted of the terminal in the first time window, send the second indication information to the network device; or

in a case that a quantity of slots of scheduled or transmitted resource of the terminal is greater than the maximum quantity of uplink slots capable of being scheduled or transmitted of the terminal in the first time window, send the second indication information to the network device; or

in a case that a quantity of uplink sub-frames of scheduled or transmitted resource of the terminal is greater than the maximum quantity of uplink sub-frames capable of being scheduled or transmitted of the terminal in the first time window, send the second indication information to the network device; or

in a case that a quantity of uplink symbols of scheduled or transmitted resource of the terminal is greater than the maximum quantity of uplink symbols capable of being scheduled or transmitted of the terminal in the first time window, send the second indication information to the network device; or

in a case that an uplink duration percentage of scheduled or transmitted resource of the terminal is greater than the maximum percentage of uplink duration capable of being scheduled or transmitted of the terminal in the first time window, send the second indication information to the network device; or

in a case that an uplink slot percentage of scheduled or transmitted resource of the terminal is greater than the maximum percentage of uplink slot capable of being scheduled or transmitted of the terminal in the first time window, send the second indication information to the network device; or

in a case that an uplink sub-frame percentage of scheduled or transmitted resource of the terminal is greater than the maximum percentage of uplink sub-frame capable of being scheduled or transmitted of the terminal in the first time window, send the second indication information to the network device; or

in a case that an uplink symbol percentage of scheduled or transmitted resource of the terminal is greater than the maximum percentage of uplink symbol capable of being scheduled or transmitted of the terminal in the first time window, send the second indication information to the network device; or

send the second indication information to the network device according to the specific absorption ratio limit information.

Optionally, the processor is further configured to:

determine, according to the first indication information, at least one of:

in a case of ensuring compliance with applicable electromagnetic power density exposure requirement or the electromagnetic radiation specific absorption ratio requirement limit, at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal;

in a case that the current uplink and downlink configuration of the network device is applied, a maximum available output power configurable by the terminal in a case of ensuring compliance with applicable electromagnetic power density exposure requirement or the electromagnetic radiation specific absorption ratio requirement limit; and

the maximum available output powers configurable by the terminal in different uplink and downlink configurations, in the case that the applicable electromagnetic power density exposure requirement or the electromagnetic radiation specific absorption ratio requirement limit is met.

Optionally, the processor is further configured to:

reconfigure a maximum available output power of the terminal, or controlling the terminal to perform a power back-off, or prohibit a transmission of at least one piece of uplink information of the terminal; where the uplink information includes: an uplink slot, or an uplink sub-frame, or an uplink symbol.

Optionally, the processor is further configured to:

determine the maximum available output power configurable by the terminal according to the first indication information, or determine the maximum available output power configurable by the terminal in a case that the current uplink and downlink configuration of the network device is applied;

in a case that a power of the terminal configured by a network device power control is greater than the maximum available output power configurable by the terminal, perform the power back-off, and controlling the power of the control terminal to back to be less than or equal to the maximum available output power configurable by the terminal.

Optionally, a back-off value of the power back-off is equal to the power configured for the terminal by the network device minus the maximum available output power configurable by the terminal.

Optionally, the processor is further configured to:

in a case of ensuring compliance with applicable electromagnetic power density exposure requirement or the electromagnetic radiation specific absorption ratio requirement limit, determine, according to the first indication information, at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal;

in a case that an uplink duration scheduled by the network device for the terminal is greater than the maximum uplink duration capable of being scheduled or transmitted of the terminal or in a case that an uplink duration percentage scheduled by the network device for the terminal is greater than the maximum percentage of uplink duration capable of being scheduled or transmitted of the terminal, prohibit a data transmission on at least one uplink time unit; or

in a case that a resource quantity of uplink slots scheduled by the network device for the terminal is greater than a maximum resource quantity of uplink slots capable of being scheduled or transmitted of the terminal or in a case that an uplink slot percentage scheduled by the network device for the terminal is greater than the maximum percentage of uplink slot capable of being scheduled or transmitted of the terminal, prohibit a data transmission on a resource of at least one uplink slot; or

in a case that a resource quantity of uplink sub-frames scheduled by the network device for the terminal is greater than the maximum quantity of uplink sub-frames capable of being scheduled or transmitted of the terminal or in a case that an uplink sub-frame percentage scheduled by the network device for the terminal is greater than the maximum percentage of uplink sub-frame capable of being scheduled or transmitted of the terminal, prohibit a data transmission on a resource of at least one uplink sub-frame; or

in a case that a resource quantity of uplink symbols scheduled by the network device for the terminal is greater than the maximum quantity of uplink symbols capable of being scheduled or transmitted of the terminal or in a case that an uplink symbol percentage scheduled by the network device for the terminal is greater than the maximum percentage of uplink symbol capable of being scheduled or transmitted of the terminal, prohibit a data transmission on a resource of at least one uplink symbol.

Optionally, the processor is further configured to:

in a case that a duration of scheduled or transmitted resource of the terminal is greater than the maximum uplink duration capable of being scheduled or transmitted of the terminal in the first time window, reconfigure a maximum available output power of the terminal or performing a power back-off by the terminal; or

in a case that a quantity of slots of scheduled or transmitted resource of the terminal is greater than the maximum quantity of uplink slots capable of being scheduled or transmitted of the terminal in the first time window, reconfigure a maximum available output power of the terminal or performing a power back-off by the terminal; or

in a case that a quantity of uplink sub-frames of scheduled or transmitted resource of the terminal is greater than the maximum quantity of uplink sub-frames capable of being scheduled or transmitted of the terminal in the first time window, reconfigure a maximum available output power of the terminal or performing a power back-off by the terminal; or

in a case that a quantity of uplink symbols of scheduled or transmitted resource of the terminal is greater than the maximum quantity of uplink symbols capable of being scheduled or transmitted of the terminal in the first time window, reconfigure a maximum available output power of the terminal or performing a power back-off by the terminal; or

in a case that an uplink duration percentage of scheduled or transmitted resource of the terminal is greater than the maximum percentage of uplink duration capable of being scheduled or transmitted of the terminal in the first time window, reconfigure a maximum available output power of the terminal or performing a power back-off by the terminal; or

in a case that an uplink slot percentage of scheduled or transmitted resource of the terminal is greater than the maximum percentage of uplink slot capable of being scheduled or transmitted of the terminal in the first time window, reconfigure a maximum available output power of the terminal or performing a power back-off by the terminal; or

in a case that an uplink sub-frame percentage of scheduled or transmitted resource of the terminal is greater than the maximum percentage of uplink sub-frame capable of being scheduled or transmitted of the terminal in the first time window, reconfigure a maximum available output power of the terminal or performing a power back-off by the terminal; or

in a case that an uplink symbol percentage of scheduled or transmitted resource of the terminal is greater than the maximum percentage of uplink symbol capable of being scheduled or transmitted of the terminal in the first time window, reconfigure a maximum available output power of the terminal or performing a power back-off by the terminal.

Optionally, one or more of the maximum uplink duration capable of being scheduled or transmitted of the terminal, the maximum quantity of uplink slots capable of being scheduled or transmitted of the terminal, the maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal is determined by the terminal according to uplink resource control information in the first indication information; or

one or more of the maximum uplink duration capable of being scheduled or transmitted of the terminal, the maximum quantity of uplink slots capable of being scheduled or transmitted of the terminal, the maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal is predefined in a criterion.

Optionally, the processor is further configured to:

report a reconfigured maximum available output power of the terminal to the network device; or

in a case that scheduled uplink resource of the terminal in the first time window exceeds a first threshold, after the terminal performs the power back-off, a power value of the terminal is less than or equal to a maximum available output power configurable by the terminal.

Optionally, the processor is further configured to:

in a case that an uplink symbol percentage scheduled or transmitted by the terminal in the first time window is greater than a capability of the terminal corresponding to the second indication information, apply all requirements for the first power class to the supported power class.

Optionally, the processor is further configured to:

in a case that an uplink symbol percentage scheduled or transmitted by the terminal in the first time window is greater than a capability of the terminal corresponding to the second indication information, lower a lower limit of a maximum transmitting power configuration value of the terminal.

An information transmission device is further provided in an embodiment of the present disclosure, applied to a terminal, including:

a first receiving module, configured to receive first indication information sent by a network device, where the first indication information includes at least one of:

location area identity information of the network device;

information of current uplink and downlink configuration of the network device;

specific absorption ratio limit information, including: an applicable electromagnetic power density exposure requirement, an electromagnetic radiation specific absorption ratio requirement limit, an applicable electromagnetic power density exposure requirement identity or an electromagnetic radiation specific absorption ratio requirement limit identity;

uplink resource control information, including at least one of: a quantity of uplink time domain resources, a quantity of uplink symbols, a quantity of uplink slots, an uplink symbol duty ratio, an uplink slot duty ratio, a maximum quantity of available uplink time domain resources of the terminal, a maximum quantity of available uplink symbols of the terminal, a maximum quantity of available uplink slots of the terminal, a maximum available uplink symbol duty ratio of the terminal, a maximum uplink slot duty ratio of the terminal, a maximum quantity of uplink time domain resources capable of being scheduled or transmitted of the terminal, a maximum quantity of uplink symbols capable of being scheduled or transmitted of the terminal, a maximum quantity of uplink slots capable of being scheduled or transmitted of the terminal, a maximum percentage of uplink duration capable of being scheduled or transmitted of the terminal, a maximum percentage of uplink slot capable of being scheduled or transmitted of the terminal, a maximum percentage of uplink sub-frame capable of being scheduled or transmitted of the terminal and a maximum percentage of uplink symbol capable of being scheduled or transmitted of the terminal in the first time window; and

first time window configuration information configured to indicate a duration of a first time window.

A terminal is further provided in an embodiment of the present disclosure, including a processor and a transceiver, where the processor is configured to control the transceiver to:

send second indication information to a network device,

where the second indication information includes at least one of:

available uplink and downlink configuration information of the terminal, in a case of ensuring compliance with applicable electromagnetic power density exposure requirement or the electromagnetic radiation specific absorption ratio requirement limit;

in a case of ensuring compliance with applicable electromagnetic power density exposure requirement or the electromagnetic radiation specific absorption ratio requirement limit, at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window;

in a case that the current uplink and downlink configuration of the network device is applied, a maximum available output power configurable by the terminal in a case of ensuring compliance with applicable electromagnetic power density exposure requirement or the electromagnetic radiation specific absorption ratio requirement limit;

first power class information of the terminal at a first working frequency band where the network device works; and

the maximum available output powers configurable by the terminal corresponding to different uplink and downlink configurations, in the case that the applicable electromagnetic power density exposure requirement or the electromagnetic radiation specific absorption ratio requirement limit is met.

Optionally, the first time window includes at least one frame structure period; or

the first time window includes at least one slot; or

the first time window includes at least one sub-frame; or,

the first time window includes at least one symbol; or

the first time window includes at least one millisecond.

Optionally, the first time window is a predefined evaluation period;

the first time window is a time range for the terminal to evaluate whether the applicable electromagnetic power density exposure requirement or the electromagnetic radiation specific absorption ratio requirement limit is met; or

the first time window is a time range of a maximum available uplink resource of the terminal in a case that the terminal evaluates that the applicable electromagnetic power density exposure requirement or the electromagnetic radiation specific absorption ratio requirement limit is met; or

the first time window is a time range of a maximum available output power configurable by the terminal in the case that the terminal evaluates that the applicable electromagnetic power density exposure requirement or the electromagnetic radiation specific absorption ratio requirement limit is met.

Optionally, the transceiver is further configured to:

prior to sending the second indication information to the network device, send, to the network device, second power class information of the terminal at the first working frequency band where the network device works;

where a transmitting power corresponding to the second power class information is larger than a transmitting power corresponding to the first power class information.

Optionally, the transceiver is further configured to:

in a case that the current uplink and downlink configuration of the network device is applied and the terminal determines that the applicable electromagnetic power density exposure requirement or the electromagnetic radiation specific absorption ratio requirement limit is not met, send, to the network device, the second power class information of the terminal at the first working frequency band where the network device works.

Optionally, the transceiver is further configured to: report a power headroom, where the power headroom is based on the maximum available output power configurable by the terminal in a case of ensuring compliance with applicable electromagnetic power density exposure requirement or the electromagnetic radiation specific absorption ratio requirement limit.

Optionally, the processor is further configured to:

in a case that an uplink symbol percentage scheduled or transmitted by the terminal in the first time window is greater than a capability of the terminal corresponding to the second indication information, apply all requirements for the first power class to the supported power class.

Optionally, the processor is further configured to:

in a case that an uplink symbol percentage scheduled or transmitted by the terminal in the first time window is greater than a capability of the terminal corresponding to the second indication information, lower a lower limit of a maximum transmitting power configuration value of the terminal.

A transmission device is further provided in an embodiment of the present disclosure, applied to a terminal, including:

a second sending module, configured to send second indication information to a network device,

where the second indication information includes at least one of:

available uplink and downlink configuration information of the terminal, in a case of ensuring compliance with applicable electromagnetic power density exposure requirement or the electromagnetic radiation specific absorption ratio requirement limit;

in a case of ensuring compliance with applicable electromagnetic power density exposure requirement or the electromagnetic radiation specific absorption ratio requirement limit, at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window;

in a case that the current uplink and downlink configuration of the network device is applied, a maximum available output power configurable by the terminal in a case of ensuring compliance with applicable electromagnetic power density exposure requirement or the electromagnetic radiation specific absorption ratio requirement limit;

first power class information of the terminal at a first working frequency band where the network device works; and

the maximum available output powers configurable by the terminal corresponding to different uplink and downlink configurations, in the case that the applicable electromagnetic power density exposure requirement or the electromagnetic radiation specific absorption ratio requirement limit is met.

A network device is further provided in an embodiment of the present disclosure, including a processor and a transceiver, where the processor is configured to control the transceiver to:

receive second indication information sent by a terminal,

where the second indication information includes at least one of:

available uplink and downlink configuration information of the terminal, in a case of ensuring compliance with applicable electromagnetic power density exposure requirement or the electromagnetic radiation specific absorption ratio requirement limit;

in a case of ensuring compliance with applicable electromagnetic power density exposure requirement or the electromagnetic radiation specific absorption ratio requirement limit, at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window;

in a case that the current uplink and downlink configuration of the network device is applied, a maximum available output power configurable by the terminal in a case of ensuring compliance with applicable electromagnetic power density exposure requirement or the electromagnetic radiation specific absorption ratio requirement limit;

first power class information of the terminal at a first working frequency band where the network device works; and

the maximum available output powers configurable by the terminal corresponding to different uplink and downlink configurations, in the case that the applicable electromagnetic power density exposure requirement or the electromagnetic radiation specific absorption ratio requirement limit is met.

Optionally, the first time window includes at least one frame structure period; or

the first time window includes at least one slot; or

the first time window includes at least one sub-frame; or,

the first time window includes at least one symbol; or

the first time window includes at least one millisecond.

Optionally, the first time window is a predefined evaluation period;

the first time window is a time range for the terminal to evaluate whether the applicable electromagnetic power density exposure requirement or the electromagnetic radiation specific absorption ratio requirement limit is met; or

the first time window is a time range of a maximum available uplink resource of the terminal in a case that the terminal evaluates that the applicable electromagnetic power density exposure requirement or the electromagnetic radiation specific absorption ratio requirement limit is met; or

the first time window is a time range of a maximum available output power configurable by the terminal in the case that the terminal evaluates that the applicable electromagnetic power density exposure requirement or the electromagnetic radiation specific absorption ratio requirement limit is met.

Optionally, the transceiver is further configured to:

prior to receiving the second indication information sent by the terminal, receive second power class information of the terminal at the first working frequency band where the network device works which is sent by the terminal;

where a transmitting power corresponding to the second power class information is larger than a transmitting power corresponding to the first power class information.

Optionally, the transceiver is further configured to:

in a case that the current uplink and downlink configuration of the network device is applied and the terminal determines that the applicable electromagnetic power density exposure requirement or the electromagnetic radiation specific absorption ratio requirement limit is not met, receive the second power class information of the terminal at the first working frequency band where the network device works which is sent by the terminal.

Optionally, the transceiver is further configured to: receive a power headroom reported by the terminal, where the power headroom is based on the maximum available output power configurable by the terminal in a case of ensuring compliance with applicable electromagnetic power density exposure requirement or the electromagnetic radiation specific absorption ratio requirement limit.

Optionally, the processor is further configured to:

perform an uplink resource scheduling or an uplink transmission for the terminal;

a duration of scheduled or transmitted resource is less than or equal to the maximum uplink duration capable of being scheduled or transmitted of the terminal in the first time window; or

a quantity of slots of scheduled or transmitted resource is less than or equal to the maximum quantity of uplink slots capable of being scheduled or transmitted of the terminal in the first time window; or

a quantity of uplink sub-frames of scheduled or transmitted resource is less than or equal to the maximum quantity of uplink sub-frames capable of being scheduled or transmitted of the terminal in the first time window; or

a quantity of uplink symbols of scheduled or transmitted resource is less than or equal to the maximum quantity of uplink symbols capable of being scheduled or transmitted of the terminal in the first time window; or

an uplink duration percentage of scheduled or transmitted resource is less than or equal to the maximum percentage of uplink duration capable of being scheduled or transmitted of the terminal in the first time window; or

an uplink slot percentage of scheduled or transmitted resource is less than or equal to the maximum percentage of uplink slot capable of being scheduled or transmitted of the terminal in the first time window; or

an uplink sub-frame percentage of scheduled or transmitted resource is less than or equal to the maximum percentage of uplink sub-frame capable of being scheduled or transmitted of the terminal in the first time window; or

an uplink symbol percentage of scheduled or transmitted resource is less than or equal to the maximum percentage of uplink symbol capable of being scheduled or transmitted of the terminal in the first time window.

Optionally, the processor is further configured to:

send a power adjustment value to the terminal; where

in a case that the power adjustment value is applied to the terminal, a transmitting power of the terminal is less than or equal to a maximum available output power configurable by the terminal; or

in the case that the power adjustment value is applied to the terminal, the transmitting power of the terminal is less than or equal to a transmitting power value corresponding to a first power class of the terminal at a first working frequency band; or

in the case that the power adjustment value is applied to the terminal, the transmitting power of the terminal is less than or equal to the maximum available output power configurable by the terminal in a case that the current uplink and downlink configuration of the network device is applied.

An information transmission device is further provided in an embodiment of the present disclosure, applied to a network device, including:

a second receiving module, configured to receive second indication information sent by a terminal,

where the second indication information includes at least one of:

available uplink and downlink configuration information of the terminal, in a case of ensuring compliance with applicable electromagnetic power density exposure requirement or the electromagnetic radiation specific absorption ratio requirement limit;

in a case of ensuring compliance with applicable electromagnetic power density exposure requirement or the electromagnetic radiation specific absorption ratio requirement limit, at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window;

in a case that the current uplink and downlink configuration of the network device is applied, a maximum available output power configurable by the terminal in a case of ensuring compliance with applicable electromagnetic power density exposure requirement or the electromagnetic radiation specific absorption ratio requirement limit;

first power class information of the terminal at a first working frequency band where the network device works; and

the maximum available output powers configurable by the terminal corresponding to different uplink and downlink configurations, in the case that the applicable electromagnetic power density exposure requirement or the electromagnetic radiation specific absorption ratio requirement limit is met.

A computer-readable storage medium is further provided in an embodiment of the present disclosure, where a computer program is stored in the computer-readable storage medium, a processor executes the program to perform the information transmission method applied to the network device hereinabove; or the processor executes the program to perform the information transmission method applied to the terminal hereinabove.

According to the information transmission method, the device, the network device and terminal in the embodiments of the present disclosure, the network device sends first indication information to the terminal, and the network device or the terminal may adjust the power or resources of the terminal in a case that the regional SAR limit requirements are satisfied, without restricting the uplink resource configuration of the high-power terminal, so that the high-power terminal may be used in more scenarios.

### BRIEF DESCRIPTION OF THE DRAWINGS

FIG. 1 is a first flow chart of an information transmission method in an embodiment of the present disclosure;

FIG. 2 is a second flow chart of an information transmission method in an embodiment of the present disclosure;

FIG. 3 is a schematic diagram of an interaction process of Example 1 in an information transmission method in an embodiment of the present disclosure;

FIG. 4 is a schematic diagram of an interaction process of Example 2 in an information transmission method in an embodiment of the present disclosure;

FIG. 5 is a third flow chart of an information transmission method in an embodiment of the present disclosure;

FIG. 6 is a fourth flow chart of an information transmission method in an embodiment of the present disclosure;

FIG. 7 is a schematic diagram of an interaction process of Example 3 in an information transmission method in an embodiment of the present disclosure;

FIG. 8 is a schematic structural diagram of a network device in an embodiment of the present disclosure; and

FIG. 9 is a schematic structural diagram of a terminal in an embodiment of the present disclosure.

### DETAILED DESCRIPTION

In order to make the technical problems, technical solutions, and advantages to be solved by the present disclosure clearer, a detailed description will be given below with reference to the drawings and specific embodiments.

As shown in FIG. 1, an information transmission method applied to a network device is provided in an embodiment of the present disclosure, where the method includes:

Step 101: sending first indication information to a terminal, where the first indication information includes at least one of:

location area identity information of the network device;

information of current uplink and downlink configuration of the network device;

specific absorption ratio limit information, including: an applicable electromagnetic power density exposure requirement, an electromagnetic radiation specific absorption ratio requirement limit, an applicable electromagnetic power density exposure requirement identity or an electromagnetic radiation specific absorption ratio requirement limit identity;

uplink resource control information, including at least one of: a quantity of uplink time domain resources, a quantity of uplink symbols, a quantity of uplink slots, an uplink symbol duty ratio, an uplink slot duty ratio, a maximum quantity of available uplink time domain resources of the terminal, a maximum quantity of available uplink symbols of the terminal, a maximum quantity of available uplink slots of the terminal, a maximum available uplink symbol duty ratio of the terminal, a maximum uplink slot duty ratio of the terminal, a maximum quantity of uplink time domain resources capable of being scheduled or transmitted of the terminal, a maximum quantity of uplink symbols capable of being scheduled or transmitted of the terminal, a maximum quantity of uplink slots capable of being scheduled or transmitted of the terminal, a maximum percentage of uplink duration capable of being scheduled or transmitted of the terminal, a maximum percentage of uplink slot capable of being scheduled or transmitted of the terminal, a maximum percentage of uplink sub-frame capable of being scheduled or transmitted of the terminal and a maximum percentage of uplink symbol capable of being scheduled or transmitted of the terminal in the first time window; and

first time window configuration information configured to indicate a duration of a first time window.

Optionally, the current uplink and downlink configuration information of the network device includes: current uplink and downlink slot configuration information of the network device or current uplink and downlink sub-frame configuration information of the network device.

The specific absorption ratio limit information is the specific absorption ratio limit information of the country where the network device is located or the operator to which it belongs. The specific absorption ratio limit information can be the applicable electromagnetic power density exposure requirement or the electromagnetic radiation specific absorption ratio requirement limit, e.g., 2.0 w/kg; or the specific absorption ratio limit information may also be the applicable electromagnetic power density exposure requirement identity or electromagnetic radiation specific absorption ratio requirement limit identity, e.g., standard 1 (corresponding to 2.0 w/kg), standard 2 (corresponding to 1.6 w/kg), etc., and the terminal and network device may determine the unique applicable electromagnetic power density exposure requirement or electromagnetic radiation specific absorption ratio requirement limit according to the applicable electromagnetic power density exposure requirement identity or electromagnetic radiation specific absorption ratio requirement limit identity.

Optionally, in the embodiment of the present disclosure, Step 101 includes:

sending the first indication information to the terminal through broadcast information, where this method is suitable for cell selection or reselection, and is used before the terminal accesses the base station;

or sending the first indication information to the terminal through a dedicated signaling; for example, send through a RRC Connection Reconfiguration or RRC Connection Setup or a Radio Resource Config Common, where this method is suitable for, when sub-carriers or sub-cells (carrier aggregation or dual connectivity) are added, the network device to inform the terminal of the relevant configuration information of the new added sub-carriers or sub-cells. For another example, it is used when sending the first RRC reconfiguration signaling (Mobility Control Info) to notify the terminal of the relevant configuration information of the target cell.

Further, Step 101 includes:

sending the first indication information to the terminal at a first working frequency band where the network device works.

For example, the terminal supports band 41 power class 2 (power class 2) 26 dBm operation, at this time the first working frequency band where the network device works is band 41 frequency band.

Optionally, in the embodiment of the present disclosure, in a case where the first indication information includes the first time window configuration information, the first time window includes at least one frame structure period; or the first time window includes at least one slot; or the first time window includes at least one sub-frame; or the first time window includes at least one symbol; or the first time window includes at least one millisecond.

Optionally, the first time window is a predefined evaluation period;

the first time window is a time reference for the terminal to evaluate whether the applicable electromagnetic power density exposure requirement or the electromagnetic radiation specific absorption ratio requirement limit is met; or

the first time window is a time range of a maximum available uplink resource of the terminal in a case that the terminal evaluates that the applicable electromagnetic power density exposure requirement or the electromagnetic radiation specific absorption ratio requirement limit is met; or

the first time window is a time range of a maximum available output power configurable by the terminal in the case that the terminal evaluates that the applicable electromagnetic power density exposure requirement or the electromagnetic radiation specific absorption ratio requirement limit is met.

Further, in the embodiment of the present disclosure, after Step 101, the method further includes:

acquiring second indication information reported by the terminal,

where the second indication information includes at least one of:

available uplink and downlink configuration information of the terminal (available uplink and downlink slot configuration information of the terminal or available uplink and downlink sub-frame configuration information of the terminal), in a case of ensuring compliance with applicable electromagnetic power density exposure requirement or the electromagnetic radiation specific absorption ratio requirement limit;

in a case of ensuring compliance with applicable electromagnetic power density exposure requirement or the electromagnetic radiation specific absorption ratio requirement limit, at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window;

in a case that the current uplink and downlink configuration of the network device is applied, a maximum available output power configurable by the terminal in a case of ensuring compliance with applicable electromagnetic power density exposure requirement or the electromagnetic radiation specific absorption ratio requirement limit;

first power class information of the terminal at a first working frequency band where the network device works; and

the maximum available output powers configurable by the terminal corresponding to different uplink and downlink configurations, in the case that the applicable electromagnetic power density exposure requirement or the electromagnetic radiation specific absorption ratio requirement limit is met.

In the above embodiment of the present disclosure, after receiving the first indication information, the terminal feeds back second indication information to the network device according to the first indication information, where the second indication information includes at least one of the foregoing information.

Further, in the above embodiments of the present disclosure, the method further includes:

prior to acquiring the second indication information, acquiring second power class information of the terminal at the first working frequency band where the network device works;

where a transmitting power corresponding to the second power class information is larger than a transmitting power corresponding to the first power class information.

Further, in a case that the current uplink and downlink configuration of the network device is applied and the terminal determines that the applicable electromagnetic power density exposure requirement or the electromagnetic radiation specific absorption ratio requirement limit is not met, the second power class information of the terminal at the first working frequency band where the network device works which is sent by the terminal is received.

For example, the terminal supports band 41 power class 2 26 dBm operation, which is the first power class, but if the ratio of the uplink and downlink slots indicated in the uplink and downlink slot configuration configured by the network side is 4:1, when the ratio of the uplink and downlink slots is configured in the standard, the terminal of power class 2 cannot meet the SAR value requirement. Therefore, when the terminal reports the capability information to the network side, the power class in band 41 will be degraded and reported, e.g., power class 3 23 dBm is reported, i.e., the second power class, the network side will use the corresponding index of power class 3 for processing when performing the power control and scheduling.

Following the above example, in the above embodiment of the present disclosure, the method further includes:

determining the maximum available output power configurable by the terminal in the first time window, according to the second indication information reported by the terminal; or

determining the first power class information of the terminal at a first working frequency band where the network device works, according to the second indication information reported by the terminal; or

determining, according to the second indication information reported by the terminal, at least one of the maximum uplink duration capable of being scheduled or transmitted of the terminal, the maximum quantity of uplink slots capable of being scheduled or transmitted of the terminal, the maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window.

It should be noted that the network device can also determine at least one of the following information without depending on the second indication information sent by the terminal:

in a case that a current uplink and downlink configuration of the network device is applied, determining a maximum available output power configurable by the terminal in a case of ensuring compliance with applicable electromagnetic power density exposure requirement or the electromagnetic radiation specific absorption ratio requirement limit; or

in the case that the current uplink and downlink configuration of the network device is applied, determining at least one of a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal; or

determining first power class information of the terminal at a first working frequency band where the network device works; or

determining a maximum available output power configurable by the terminal in the first time window; or

determining at least one of a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window.

In summary, after the network device determines the capability information of the terminal based on the second indication information or the network device determines the capability information of the terminal without depending on the second indication information, the method further includes:

the network device performing an uplink resource scheduling or uplink transmission for the terminal;

where a duration of scheduled or transmitted resource is less than or equal to a maximum uplink duration capable of being scheduled or transmitted of the terminal; or

a quantity of slots of the scheduled or transmitted resource is less than or equal to a maximum quantity of uplink slots capable of being scheduled or transmitted of the terminal; or

a quantity of uplink sub-frames of the scheduled or transmitted resource is less than or equal to a maximum quantity of uplink sub-frames capable of being scheduled or transmitted of the terminal; or

a quantity of uplink symbols of the scheduled or transmitted resource is less than or equal to a maximum quantity of uplink symbols capable of being scheduled or transmitted of the terminal; or

an uplink duration percentage of the scheduled or transmitted resource is less than or equal to a maximum percentage of uplink duration capable of being scheduled or transmitted of the terminal; or

an uplink slot percentage of the scheduled or transmitted resource is less than or equal to a maximum percentage of uplink slot capable of being scheduled or transmitted of the terminal; or

an uplink sub-frame percentage of the scheduled or transmitted resource is less than or equal to a maximum percentage of uplink sub-frame capable of being scheduled or transmitted of the terminal; or

an uplink symbol percentage of the scheduled or transmitted resource is less than or equal to a maximum percentage of uplink symbol capable of being scheduled or transmitted of the terminal;

and/or, after the network device determines the capability information of the terminal based on the second indication information or the network device determines the capability information of the terminal without depending on the second indication information, the method further includes:

sending, by the network device, a power adjustment value to the terminal; where

in a case that the power adjustment value is applied to the terminal, a transmitting power of the terminal is less than or equal to a maximum available output power configurable by the terminal; or

in the case that the power adjustment value is applied to the terminal, the transmitting power of the terminal is less than or equal to a transmitting power value corresponding to a first power class of the terminal at a first working frequency band; or

in the case that the power adjustment value is applied to the terminal, the transmitting power of the terminal is less than or equal to the maximum available output power configurable by the terminal in a case that the current uplink and downlink configuration of the network device is applied.

In summary, according to the above embodiments of the present disclosure, the network device sends first indication information to the terminal, and the network device or the terminal may adjust the power or resources of the terminal in a case that the regional SAR limit requirements are satisfied, without restricting the uplink resource configuration of the high-power terminal, so that the high-power terminal may be used in more scenarios.

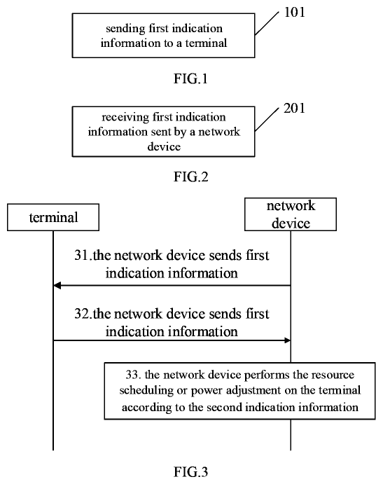

As shown in FIG. 2, an information transmission method applied to a terminal is further provided in an embodiment of the present disclosure, including:

Step 201: receiving first indication information sent by a network device, where the first indication information includes at least one of:

location area identity information of the network device;

information of current uplink and downlink configuration of the network device;

specific absorption ratio limit information, including: an applicable electromagnetic power density exposure requirement, an electromagnetic radiation specific absorption ratio requirement limit, an applicable electromagnetic power density exposure requirement identity or an electromagnetic radiation specific absorption ratio requirement limit identity;

uplink resource control information, including at least one of: a quantity of uplink time domain resources, a quantity of uplink symbols, a quantity of uplink slots, an uplink symbol duty ratio, an uplink slot duty ratio, a maximum quantity of available uplink time domain resources of the terminal, a maximum quantity of available uplink symbols of the terminal, a maximum quantity of available uplink slots of the terminal, a maximum available uplink symbol duty ratio of the terminal, a maximum uplink slot duty ratio of the terminal, a maximum quantity of uplink time domain resources capable of being scheduled or transmitted of the terminal, a maximum quantity of uplink symbols capable of being scheduled or transmitted of the terminal, a maximum quantity of uplink slots capable of being scheduled or transmitted of the terminal, a maximum percentage of uplink duration capable of being scheduled or transmitted of the terminal, a maximum percentage of uplink slot capable of being scheduled or transmitted of the terminal, a maximum percentage of uplink sub-frame capable of being scheduled or transmitted of the terminal and a maximum percentage of uplink symbol capable of being scheduled or transmitted of the terminal in the first time window; and

first time window configuration information configured to indicate a duration of a first time window.

Optionally, the current uplink and downlink configuration information of the network device includes: current uplink and downlink slot configuration information of the network device or current uplink and downlink sub-frame configuration information of the network device.

The specific absorption ratio limit information is the specific absorption ratio limit information of the country where the network device is located or the operator to which it belongs. The specific absorption ratio limit information can be the applicable electromagnetic power density exposure requirement or the electromagnetic radiation specific absorption ratio requirement limit, e.g., 2.0 w/kg; or the specific absorption ratio limit information may also be the applicable electromagnetic power density exposure requirement identity or electromagnetic radiation specific absorption ratio requirement limit identity, e.g., standard 1 (corresponding to 2.0 w/kg), standard 2 (corresponding to 1.6 w/kg), etc., and the terminal and network device may determine the unique applicable electromagnetic power density exposure requirement or electromagnetic radiation specific absorption ratio requirement limit according to the applicable electromagnetic power density exposure requirement identity or electromagnetic radiation specific absorption ratio requirement limit identity.

Optionally, in the above embodiment of the present disclosure, Step 201 includes:

Optionally, in the embodiment of the present disclosure, Step 201 includes:

receiving the first indication information which is sent by the network device through broadcast information, e.g., SIB1 (system information block 1), where this method is suitable for cell selection or reselection, and is used before the terminal accesses the base station;

or receiving the first indication information which is sent by the network device through a dedicated signaling; for example, send through a RRC Connection Reconfiguration or RRC Connection Setup or a Radio Resource Config Common, where this method is suitable for, when sub-carriers or sub-cells (carrier aggregation or dual connectivity) are added, the network device to inform the terminal of the relevant configuration information of the new added sub-carriers or sub-cells. For another example, it is used when sending the first RRC reconfiguration signaling (Mobility Control Info) to notify the terminal of the relevant configuration information of the target cell.

Further, Step 201 includes:

receiving the first indication information which is sent by the network device at a first working frequency band where the network device works.

For example, the terminal supports band 41 power class 2 (power class 2) 26 dBm operation, at this time the first working frequency band where the network device works is band 41 frequency band.

Optionally, in the embodiment of the present disclosure, in a case where the first indication information includes the first time window configuration information, the first time window includes at least one frame structure period; or the first time window includes at least one slot; or the first time window includes at least one sub-frame; or the first time window includes at least one symbol; or the first time window includes at least one millisecond.

Optionally, the first time window is a predefined evaluation period;

the first time window is a time reference for the terminal to evaluate whether the applicable electromagnetic power density exposure requirement or the electromagnetic radiation specific absorption ratio requirement limit is met; or

the first time window is a time range of a maximum available uplink resource of the terminal in a case that the terminal evaluates that the applicable electromagnetic power density exposure requirement or the electromagnetic radiation specific absorption ratio requirement limit is met; or

the first time window is a time range of a maximum available output power configurable by the terminal in the case that the terminal evaluates that the applicable electromagnetic power density exposure requirement or the electromagnetic radiation specific absorption ratio requirement limit is met.

Further, in the above embodiment of the present disclosure, after Step 201, the method further includes:

reporting second indication information to the network device according to the first indication information, where the second indication information includes at least one of:

available uplink and downlink configuration information of the terminal (available uplink and downlink slot configuration information of the terminal or available uplink and downlink sub-frame configuration information of the terminal), in a case of ensuring compliance with applicable electromagnetic power density exposure requirement or the electromagnetic radiation specific absorption ratio requirement limit;

at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window;

in a case that the current uplink and downlink configuration of the network device is applied, a maximum available output power configurable by the terminal in a case of ensuring compliance with applicable electromagnetic power density exposure requirement or the electromagnetic radiation specific absorption ratio requirement limit;

first power class information of the terminal at a first working frequency band where the network device works; and

maximum available output powers configurable by the terminal corresponding to different uplink and downlink configurations, in the case that the applicable electromagnetic power density exposure requirement or the electromagnetic radiation specific absorption ratio requirement limit is met.

Optionally, in the above embodiment of the present disclosure, after Step 201, the method further includes:

reporting second indication information to the network device, where the second indication information includes at least one of:

available uplink and downlink configuration information of the terminal (available uplink and downlink slot configuration information of the terminal or available uplink and downlink sub-frame configuration information of the terminal), in a case of ensuring compliance with applicable electromagnetic power density exposure requirement or the electromagnetic radiation specific absorption ratio requirement limit;

at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window;

in a case that the current uplink and downlink configuration of the network device is applied, a maximum available output power configurable by the terminal in a case of ensuring compliance with applicable electromagnetic power density exposure requirement or the electromagnetic radiation specific absorption ratio requirement limit;

first power class information of the terminal at a first working frequency band where the network device works; and

maximum available output powers configurable by the terminal corresponding to different uplink and downlink configurations, in the case that the applicable electromagnetic power density exposure requirement or the electromagnetic radiation specific absorption ratio requirement limit is met. In the above embodiment of the present disclosure, after receiving the first indication information, the terminal feeds back second indication information to the network device according to the first indication information, and the second indication information includes at least one of the foregoing information.

Further, in the above embodiments of the present disclosure, the method further includes:

prior to reporting the second indication information to the network device, sending, to the network device, second power class information of the terminal at the first working frequency band where the network device works;

where a transmitting power corresponding to the second power class information is larger than a transmitting power corresponding to the first power class information.

Further, in a case that the current uplink and downlink configuration of the network device is applied and the terminal determines that the applicable electromagnetic power density exposure requirement or the electromagnetic radiation specific absorption ratio requirement limit is not met, the second power class information of the terminal at the first working frequency band where the network device works is sent to the network device.

For example, the terminal supports band 41 power class 2 26 dBm operation, which is the first power class, but if the ratio of the uplink and downlink slots indicated in the uplink and downlink slot configuration configured by the network side is 4:1, when the ratio of the uplink and downlink slots is configured in the standard, the terminal of power class 2 cannot meet the SAR value requirement. Therefore, when the terminal reports the capability information to the network side, the power class in band 41 will be degraded and reported, e.g., power class 3 23 dBm is reported, i.e., the second power class, the network side will use the corresponding index of power class 3 for processing when performing the power control and scheduling.

Following the above example, in the above embodiment of the present disclosure, in a case that the first indication information includes the location area identity information of the network device, the method further includes:

determining, according to a country identity in the location area identity information of the network device, a country where the network device is located, and acquiring the applicable electromagnetic power density exposure requirement or the electromagnetic radiation specific absorption ratio requirement limit corresponding to the country; or

determining, according to a country identity and an operator identity in the location area identity information of the network device, a country and an operator where the network device is located, and acquiring the applicable electromagnetic power density exposure requirement or the electromagnetic radiation specific absorption ratio requirement limit corresponding to the country and the operator.

That is, the terminal determines the applicable electromagnetic power density exposure requirement or electromagnetic radiation specific absorption ratio requirement limit of the country or country and the operator where the network device is located and belong to, and the applicable electromagnetic power density exposure requirement or electromagnetic radiation specific absorption ratio requirement limit is defined in the standard, or pre-stored in the terminal, or determined according to the specific absorption ratio limit information in the first indication information.

The terminal determining the country or country where the network device is located and the operator to which it belongs includes: the terminal determining the country where the network device is located according to the country identification code in the first indication information; or the terminal determining country where the network device is located and the operator to which it belongs according to the country identification code and operator identification code in the first indication information.

Further, in the above embodiment of the present disclosure, the reporting the second indication information to the network device according to the first indication information includes:

in a case that a second power class of the terminal at the first working frequency band where the network device works does not meet the applicable electromagnetic power density exposure requirement or the electromagnetic radiation specific absorption ratio requirement limit, sending the second indication information to the network device; or

in a case that the terminal with the current uplink and downlink configuration of the network device does not meet the applicable electromagnetic power density exposure requirement or the electromagnetic radiation specific absorption ratio requirement limit, sending the second indication information to the network device; or

in a case that a duration of scheduled or transmitted resource of the terminal is greater than the maximum uplink duration capable of being scheduled or transmitted of the terminal in the first time window, sending the second indication information to the network device; or

in a case that a quantity of slots of scheduled or transmitted resource of the terminal is greater than the maximum quantity of uplink slots capable of being scheduled or transmitted of the terminal in the first time window, sending the second indication information to the network device; or

in a case that a quantity of uplink sub-frames of scheduled or transmitted resource of the terminal is greater than the maximum quantity of uplink sub-frames capable of being scheduled or transmitted of the terminal in the first time window, sending the second indication information to the network device; or

in a case that a quantity of uplink symbols of scheduled or transmitted resource of the terminal is greater than the maximum quantity of uplink symbols capable of being scheduled or transmitted of the terminal in the first time window, sending the second indication information to the network device; or

in a case that an uplink duration percentage of scheduled or transmitted resource of the terminal is greater than the maximum percentage of uplink duration capable of being scheduled or transmitted of the terminal in the first time window, sending the second indication information to the network device; or

in a case that an uplink slot percentage of scheduled or transmitted resource of the terminal is greater than the maximum percentage of uplink slot capable of being scheduled or transmitted of the terminal in the first time window, sending the second indication information to the network device; or

in a case that an uplink sub-frame percentage of scheduled or transmitted resource of the terminal is greater than the maximum percentage of uplink sub-frame capable of being scheduled or transmitted of the terminal in the first time window, sending the second indication information to the network device; or

in a case that an uplink symbol percentage of scheduled or transmitted resource of the terminal is greater than the maximum percentage of uplink symbol capable of being scheduled or transmitted of the terminal in the first time window, sending the second indication information to the network device; or

sending the second indication information to the network device according to the specific absorption ratio limit information.

Optionally, in the above embodiment of the present disclosure, the reporting the second indication information to the network device includes: in a case that a second power class of the terminal at the first working frequency band where the network device works does not meet the applicable electromagnetic power density exposure requirement or the electromagnetic radiation specific absorption ratio requirement limit, sending the second indication information to the network device; or in a case that the terminal with the current uplink and downlink configuration of the network device does not meet the applicable electromagnetic power density exposure requirement or the electromagnetic radiation specific absorption ratio requirement limit, sending the second indication information to the network device; or in a case that a duration of scheduled or transmitted resource of the terminal is greater than the maximum uplink duration capable of being scheduled or transmitted of the terminal in the first time window, sending the second indication information to the network device; or in a case that a quantity of slots of scheduled or transmitted resource of the terminal is greater than the maximum quantity of uplink slots capable of being scheduled or transmitted of the terminal in the first time window, sending the second indication information to the network device; or in a case that a quantity of uplink sub-frames of scheduled or transmitted resource of the terminal is greater than the maximum quantity of uplink sub-frames capable of being scheduled or transmitted of the terminal in the first time window, sending the second indication information to the network device; or in a case that a quantity of uplink symbols of scheduled or transmitted resource of the terminal is greater than the maximum quantity of uplink symbols capable of being scheduled or transmitted of the terminal in the first time window, sending the second indication information to the network device; or in a case that an uplink duration percentage of scheduled or transmitted resource of the terminal is greater than the maximum percentage of uplink duration capable of being scheduled or transmitted of the terminal in the first time window, sending the second indication information to the network device; or in a case that an uplink slot percentage of scheduled or transmitted resource of the terminal is greater than the maximum percentage of uplink slot capable of being scheduled or transmitted of the terminal in the first time window, sending the second indication information to the network device; or in a case that an uplink sub-frame percentage of scheduled or transmitted resource of the terminal is greater than the maximum percentage of uplink sub-frame capable of being scheduled or transmitted of the terminal in the first time window, sending the second indication information to the network device; or in a case that an uplink symbol percentage of scheduled or transmitted resource of the terminal is greater than the maximum percentage of uplink symbol capable of being scheduled or transmitted of the terminal in the first time window, sending the second indication information to the network device; or sending the second indication information to the network device according to the specific absorption ratio limit information.

It should be noted that in the above embodiment of the present disclosure, after the terminal reports the second indication information to the network device, the network device may determine the capability information of the terminal based on the second indication information, and perform the resource scheduling and/or power adjustment on the terminal based on the capability information of the terminal. The specific manner in which the network device performs resource scheduling and/or power adjustment of the terminal has been described in detail in the information transmission method applied to the network device, and the description is not repeated here.

It should be noted that, in another embodiment of the present disclosure, after the terminal receives the first indication information, the method further includes:

determining, according to the first indication information, at least one of:

in a case of ensuring compliance with applicable electromagnetic power density exposure requirement or the electromagnetic radiation specific absorption ratio requirement limit, at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal;

in a case that the current uplink and downlink configuration of the network device is applied, a maximum available output power configurable by the terminal in a case of ensuring compliance with applicable electromagnetic power density exposure requirement or the electromagnetic radiation specific absorption ratio requirement limit; and

the maximum available output powers configurable by the terminal in different uplink and downlink configurations, in the case that the applicable electromagnetic power density exposure requirement or the electromagnetic radiation specific absorption ratio requirement limit is met.

Based on the foregoing information determined by the terminal, the method further includes:

reconfiguring a maximum available output power of the terminal, or controlling the terminal to perform a power back-off, or prohibiting a transmission of at least one piece of uplink information of the terminal; where the uplink information includes: an uplink slot, or an uplink sub-frame, or an uplink symbol.

Further, the controlling the terminal to perform the power back-off includes:

determining the maximum available output power configurable by the terminal according to the first indication information, or determining the maximum available output power configurable by the terminal in a case that the current uplink and downlink configuration of the network device is applied;

in a case that a power of the terminal configured by a network device power control is greater than the maximum available output power configurable by the terminal, performing the power back-off, and controlling the power of the control terminal to back to be less than or equal to the maximum available output power configurable by the terminal.

Optionally, a back-off value of the power back-off is equal to the power configured for the terminal by the network device minus the maximum available output power configurable by the terminal.

That is, the terminal determines that, in a case that the current uplink and downlink configuration information of the network device included in the first indication information is applied and the terminal of the first power class in the first working frequency band meets the SAR limit of the country where the network device is located or the operator which it belongs to, the maximum available output power PSAR max configurable by the terminal, which is defined in the standard or pre-stored in the terminal. When the terminal power value P configured by the network device exceeds PSAR max, P is set to PSAR max, and the power back-off value of the terminal is P-PSAR max.

Optionally, the prohibiting the transmission of the at least one piece of uplink information of the terminal includes:

in a case of ensuring compliance with applicable electromagnetic power density exposure requirement or the electromagnetic radiation specific absorption ratio requirement limit, determining, according to the first indication information, at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal;

in a case that an uplink duration scheduled by the network device for the terminal is greater than the maximum uplink duration capable of being scheduled or transmitted of the terminal or in a case that an uplink duration percentage scheduled by the network device for the terminal is greater than the maximum percentage of uplink duration capable of being scheduled or transmitted of the terminal, prohibiting a data transmission on at least one uplink time unit; or

in a case that a resource quantity of uplink slots scheduled by the network device for the terminal is greater than a maximum resource quantity of uplink slots capable of being scheduled or transmitted of the terminal or in a case that an uplink slot percentage scheduled by the network device for the terminal is greater than the maximum percentage of uplink slot capable of being scheduled or transmitted of the terminal, prohibiting a data transmission on a resource of at least one uplink slot; or

in a case that a resource quantity of uplink sub-frames scheduled by the network device for the terminal is greater than the maximum quantity of uplink sub-frames capable of being scheduled or transmitted of the terminal or in a case that an uplink sub-frame percentage scheduled by the network device for the terminal is greater than the maximum percentage of uplink sub-frame capable of being scheduled or transmitted of the terminal, prohibiting a data transmission on a resource of at least one uplink sub-frame; or

in a case that a resource quantity of uplink symbols scheduled by the network device for the terminal is greater than the maximum quantity of uplink symbols capable of being scheduled or transmitted of the terminal or in a case that an uplink symbol percentage scheduled by the network device for the terminal is greater than the maximum percentage of uplink symbol capable of being scheduled or transmitted of the terminal, prohibiting a data transmission on a resource of at least one uplink symbol.

Optionally, the method further includes:

in a case that a duration of scheduled or transmitted resource of the terminal is greater than the maximum uplink duration capable of being scheduled or transmitted of the terminal in the first time window, reconfiguring, by the terminal, a maximum available output power of the terminal or performing a power back-off by the terminal; or

in a case that a quantity of slots of scheduled or transmitted resource of the terminal is greater than the maximum quantity of uplink slots capable of being scheduled or transmitted of the terminal in the first time window, reconfiguring, by the terminal, a maximum available output power of the terminal or performing a power back-off by the terminal; or

in a case that a quantity of uplink sub-frames of scheduled or transmitted resource of the terminal is greater than the maximum quantity of uplink sub-frames capable of being scheduled or transmitted of the terminal in the first time window, reconfiguring, by the terminal, a maximum available output power of the terminal or performing a power back-off by the terminal; or

in a case that a quantity of uplink symbols of scheduled or transmitted resource of the terminal is greater than the maximum quantity of uplink symbols capable of being scheduled or transmitted of the terminal in the first time window, reconfiguring, by the terminal, a maximum available output power of the terminal or performing a power back-off by the terminal; or

in a case that an uplink duration percentage of scheduled or transmitted resource of the terminal is greater than the maximum percentage of uplink duration capable of being scheduled or transmitted of the terminal in the first time window, reconfiguring, by the terminal, a maximum available output power of the terminal or performing a power back-off by the terminal; or

in a case that an uplink slot percentage of scheduled or transmitted resource of the terminal is greater than the maximum percentage of uplink slot capable of being scheduled or transmitted of the terminal in the first time window, reconfiguring, by the terminal, a maximum available output power of the terminal or performing a power back-off by the terminal; or

in a case that an uplink sub-frame percentage of scheduled or transmitted resource of the terminal is greater than the maximum percentage of uplink sub-frame capable of being scheduled or transmitted of the terminal in the first time window, reconfiguring, by the terminal, a maximum available output power of the terminal or performing a power back-off by the terminal; or

in a case that an uplink symbol percentage of scheduled or transmitted resource of the terminal is greater than the maximum percentage of uplink symbol capable of being scheduled or transmitted of the terminal in the first time window, reconfiguring, by the terminal, a maximum available output power of the terminal or performing a power back-off by the terminal.

Optionally, one or more of the maximum uplink duration capable of being scheduled or transmitted of the terminal, the maximum quantity of uplink slots capable of being scheduled or transmitted of the terminal, the maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal is determined by the terminal according to uplink resource control information in the first indication information; or

one or more of the maximum uplink duration capable of being scheduled or transmitted of the terminal, the maximum quantity of uplink slots capable of being scheduled or transmitted of the terminal, the maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal is predefined in a criterion.

Optionally, the method further includes:

reporting a reconfigured maximum available output power of the terminal to the network device; or

in a case that scheduled uplink resource of the terminal in the first time window exceeds a first threshold, after the terminal performs the power back-off, a power value of the terminal is less than or equal to a maximum available output power configurable by the terminal.

Specifically, the method further includes:

determining the first threshold according to the first indication information, where the first threshold is the maximum quantity of uplink time domain resources that can be scheduled or transmitted by the terminal within the first time window.

To sum up, according to the above embodiments of the present disclosure, after receiving the first indication information, the terminal may reconfigure the maximum available output power of the terminal based on the first indication information or control the terminal to perform the power back-off or prohibit the transmission of at least one uplink information of the terminal; or after receiving the first indication information, the terminal sends second indication information to the network device based on the first indication information, and the network device may perform the resource scheduling and/or power adjustment on the terminal based on the second indication information. That is, the network device or terminal may adjust the power or resources of the terminal while ensuring that the regional SAR limit requirement is met, without restricting the uplink resource configuration of the high-power terminal, so that the high-power terminal may be used in more scenarios.

### Example One

As shown in FIG. 3, the interaction process between the network device and the terminal includes:

Step 31: the network device sends first indication information;

Step 32: the terminal sends second indication information to the network device;

Step 33: the network device performs the resource scheduling or power adjustment on the terminal according to the second indication information.

It should be noted that the content and transmission method included in the first indication information in Example 1, the content and transmission method included in the second indication information and how the network device performs resource scheduling or power adjustment on the terminal according to the second indication information correspond to the description in the above embodiment, which will not be repeated here.

### Example Two

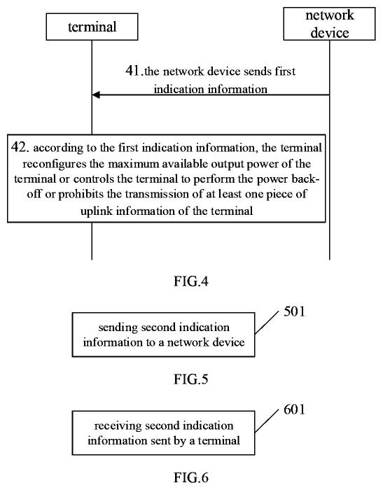

As shown in FIG. 4, the interaction process between the network device and the terminal includes:

Step 41: the network device sends first indication information;

Step 42: according to the first indication information, the terminal reconfigures the maximum available output power of the terminal or controls the terminal to perform the power back-off or prohibits the transmission of at least one piece of uplink information of the terminal.

It should be noted that the content and transmission method of the first indication information in Example 2 and how the terminal reconfigures the maximum available output power of the terminal or controls the terminal to perform power back-off or prohibit transmission of at least one piece of uplink information of the terminal according to the first indication information correspond to the description in the above embodiment, and the details thereof are not repeated here.

As shown in FIG. 5, an information transmission method is further provided in an embodiment of the present disclosure, which is applied to a terminal, and the method includes:

Step 501: sending second indication information to a network device.

where the second indication information includes at least one of:

available uplink and downlink configuration information of the terminal (available uplink and downlink slot configuration information of the terminal or available uplink and downlink sub-frame configuration information of the terminal), in a case of ensuring compliance with applicable electromagnetic power density exposure requirement or the electromagnetic radiation specific absorption ratio requirement limit;

in a case of ensuring compliance with applicable electromagnetic power density exposure requirement or the electromagnetic radiation specific absorption ratio requirement limit, at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window;

in a case that the current uplink and downlink configuration of the network device is applied, a maximum available output power configurable by the terminal in a case of ensuring compliance with applicable electromagnetic power density exposure requirement or the electromagnetic radiation specific absorption ratio requirement limit;

first power class information of the terminal at a first working frequency band where the network device works; and

the maximum available output powers configurable by the terminal corresponding to different uplink and downlink configurations, in the case that the applicable electromagnetic power density exposure requirement or the electromagnetic radiation specific absorption ratio requirement limit is met.

Optionally, in the above embodiment of the present disclosure, the first time window includes: the first time window includes at least one frame structure period; or the first time window includes at least one slot; or the first time window includes at least one sub-frame; or the first time window includes at least one symbol; or the first time window includes at least one millisecond.

Optionally, the first time window is a predefined evaluation period;

the first time window is a time range for the terminal to evaluate whether the applicable electromagnetic power density exposure requirement or the electromagnetic radiation specific absorption ratio requirement limit is met; or

the first time window is a time range of a maximum available uplink resource of the terminal in a case that the terminal evaluates that the applicable electromagnetic power density exposure requirement or the electromagnetic radiation specific absorption ratio requirement limit is met; or

the first time window is a time range of a maximum available output power configurable by the terminal in the case that the terminal evaluates that the applicable electromagnetic power density exposure requirement or the electromagnetic radiation specific absorption ratio requirement limit is met.

Further, in the above embodiments of the present disclosure, the method further includes:

prior to sending the second indication information to the network device, sending, to the network device, second power class information of the terminal at the first working frequency band where the network device works;

where a transmitting power corresponding to the second power class information is larger than a transmitting power corresponding to the first power class information.

Further, in the above embodiment of the present disclosure, the sending to the network device the second power class information of the terminal at the first working frequency band where the network device works includes:

in a case that the current uplink and downlink configuration of the network device is applied and the terminal determines that the applicable electromagnetic power density exposure requirement or the electromagnetic radiation specific absorption ratio requirement limit is not met, sending, to the network device, the second power class information of the terminal at the first working frequency band where the network device works.

For example, the terminal supports band 41 power class 2 26 dBm operation, which is the first power class, but if the ratio of the uplink and downlink slots indicated in the uplink and downlink slot configuration configured by the network side is 4:1, when the ratio of the uplink and downlink slots is configured in the standard, the terminal of power class 2 cannot meet the SAR value requirement. Therefore, when the terminal reports the capability information to the network side, the power class in band 41 will be degraded and reported, e.g., power class 3 23 dBm is reported, i.e., the second power class, the network side will use the corresponding index of power class 3 for processing when performing the power control and scheduling.

Further, in the above embodiments of the present disclosure, the method further includes:

reporting a power headroom by the terminal, where the power headroom is based on the maximum available output power configurable by the terminal in a case of ensuring compliance with applicable electromagnetic power density exposure requirement or the electromagnetic radiation specific absorption ratio requirement limit.

To sum up, according to the above embodiments of the present disclosure, the terminal actively reports the second indication information (equivalent to the capability information of the terminal) to the network device, and the network device may, according to the second indication information reported by the terminal, adjust the power or resources of the terminal in a case that the regional SAR value requirements are satisfied, without restricting the uplink resource configuration of the high-power terminal, so that the high-power terminal may be used in more scenarios.

As shown in FIG. 6, an information transmission method is further provided in an embodiment of the present disclosure, which is applied to a network device, and the method includes:

Step 601: receiving second indication information sent by a terminal,

where the second indication information includes at least one of:

available uplink and downlink configuration information of the terminal, in a case of ensuring compliance with applicable electromagnetic power density exposure requirement or the electromagnetic radiation specific absorption ratio requirement limit;

in a case of ensuring compliance with applicable electromagnetic power density exposure requirement or the electromagnetic radiation specific absorption ratio requirement limit, at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window;

in a case that the current uplink and downlink configuration of the network device is applied, a maximum available output power configurable by the terminal in a case of ensuring compliance with applicable electromagnetic power density exposure requirement or the electromagnetic radiation specific absorption ratio requirement limit;

first power class information of the terminal at a first working frequency band where the network device works; and

the maximum available output powers configurable by the terminal corresponding to different uplink and downlink configurations, in the case that the applicable electromagnetic power density exposure requirement or the electromagnetic radiation specific absorption ratio requirement limit is met.

Optionally, in the above embodiment of the present disclosure, the first time window includes: the first time window includes at least one frame structure period; or the first time window includes at least one slot; or the first time window includes at least one sub-frame; or the first time window includes at least one symbol; or the first time window includes at least one millisecond.

Optionally, the first time window is a predefined evaluation period;

the first time window is a time range for the terminal to evaluate whether the applicable electromagnetic power density exposure requirement or the electromagnetic radiation specific absorption ratio requirement limit is met; or

the first time window is a time range of a maximum available uplink resource of the terminal in a case that the terminal evaluates that the applicable electromagnetic power density exposure requirement or the electromagnetic radiation specific absorption ratio requirement limit is met; or

the first time window is a time range of a maximum available output power configurable by the terminal in the case that the terminal evaluates that the applicable electromagnetic power density exposure requirement or the electromagnetic radiation specific absorption ratio requirement limit is met.

Further, in the above embodiments of the present disclosure, the method further includes:

prior to receiving the second indication information sent by the terminal, receiving second power class information of the terminal at the first working frequency band where the network device works which is sent by the terminal;

where a transmitting power corresponding to the second power class information is larger than a transmitting power corresponding to the first power class information.

Specifically, the receiving the second power class information of the terminal at the first working frequency band where the network device works which is sent by the terminal includes:

in a case that the current uplink and downlink configuration of the network device is applied and the terminal determines that the applicable electromagnetic power density exposure requirement or the electromagnetic radiation specific absorption ratio requirement limit is not met, receiving the second power class information of the terminal at the first working frequency band where the network device works which is sent by the terminal.

For example, the terminal supports band 41 power class 2 26 dBm operation, which is the first power class, but if the ratio of the uplink and downlink slots indicated in the uplink and downlink slot configuration configured by the network side is 4:1, when the ratio of the uplink and downlink slots is configured in the standard, the terminal of power class 2 cannot meet the SAR value requirement. Therefore, when the terminal reports the capability information to the network side, the power class in band 41 will be degraded and reported, e.g., power class 3 23 dBm is reported, i.e., the second power class, the network side will use the corresponding index of power class 3 for processing when performing the power control and scheduling.

Further, in the above embodiments of the present disclosure, the method further includes:

receiving a power headroom reported by the terminal, where the power headroom is based on the maximum available output power configurable by the terminal in a case of ensuring compliance with applicable electromagnetic power density exposure requirement or the electromagnetic radiation specific absorption ratio requirement limit.

Further, the network device can perform the resource scheduling or power adjustment on the terminal based on the second indication information. Specifically, the method further includes:

the network device performing an uplink resource scheduling or an uplink transmission for the terminal;

a duration of scheduled or transmitted resource is less than or equal to the maximum uplink duration capable of being scheduled or transmitted of the terminal in the first time window; or

a quantity of slots of scheduled or transmitted resource is less than or equal to the maximum quantity of uplink slots capable of being scheduled or transmitted of the terminal in the first time window; or

a quantity of uplink sub-frames of scheduled or transmitted resource is less than or equal to the maximum quantity of uplink sub-frames capable of being scheduled or transmitted of the terminal in the first time window; or

a quantity of uplink symbols of scheduled or transmitted resource is less than or equal to the maximum quantity of uplink symbols capable of being scheduled or transmitted of the terminal in the first time window; or

an uplink duration percentage of scheduled or transmitted resource is less than or equal to the maximum percentage of uplink duration capable of being scheduled or transmitted of the terminal in the first time window; or

an uplink slot percentage of scheduled or transmitted resource is less than or equal to the maximum percentage of uplink slot capable of being scheduled or transmitted of the terminal in the first time window; or

an uplink sub-frame percentage of scheduled or transmitted resource is less than or equal to the maximum percentage of uplink sub-frame capable of being scheduled or transmitted of the terminal in the first time window; or

an uplink symbol percentage of scheduled or transmitted resource is less than or equal to the maximum percentage of uplink symbol capable of being scheduled or transmitted of the terminal in the first time window;

and/or, in the above embodiment of the present disclosure, the method further includes:

sending, by the network device, a power adjustment value to the terminal; where

in a case that the power adjustment value is applied to the terminal, a transmitting power of the terminal is less than or equal to a maximum available output power configurable by the terminal; or

in the case that the power adjustment value is applied to the terminal, the transmitting power of the terminal is less than or equal to a transmitting power value corresponding to a first power class of the terminal at a first working frequency band; or

in the case that the power adjustment value is applied to the terminal, the transmitting power of the terminal is less than or equal to the maximum available output power configurable by the terminal in a case that the current uplink and downlink configuration of the network device is applied.

### Example 3

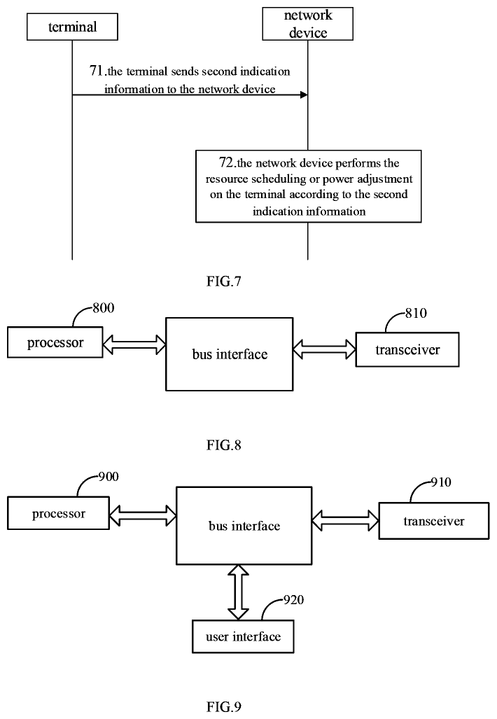

As shown in FIG. 7, the interaction process between the network device and the terminal includes:

Step 71: the terminal sends second indication information to the network device.

Step 72: the network device performs the resource scheduling or power adjustment on the terminal according to the second indication information.

To sum up, according to the above embodiments of the present disclosure, the terminal actively reports the second indication information (equivalent to the capability information of the terminal) to the network device, and the network device may, according to the second indication information reported by the terminal, adjust the power or resources of the terminal in a case that the regional SAR value requirements are satisfied, without restricting the uplink resource configuration of the high-power terminal, so that the high-power terminal may be used in more scenarios.

As shown in FIG. 8, a network device is further provided in an embodiment of the present disclosure, including a processor 800 and a transceiver 810, where the processor 800 is configured to control the transceiver to:

send first indication information to a terminal, where the first indication information includes at least one of:

location area identity information of the network device;

information of current uplink and downlink configuration of the network device;

specific absorption ratio limit information, including: an applicable electromagnetic power density exposure requirement, an electromagnetic radiation specific absorption ratio requirement limit, an applicable electromagnetic power density exposure requirement identity or an electromagnetic radiation specific absorption ratio requirement limit identity;

uplink resource control information, including at least one of: a quantity of uplink time domain resources, a quantity of uplink symbols, a quantity of uplink slots, an uplink symbol duty ratio, an uplink slot duty ratio, a maximum quantity of available uplink time domain resources of the terminal, a maximum quantity of available uplink symbols of the terminal, a maximum quantity of available uplink slots of the terminal, a maximum available uplink symbol duty ratio of the terminal, a maximum uplink slot duty ratio of the terminal, a maximum quantity of uplink time domain resources capable of being scheduled or transmitted of the terminal, a maximum quantity of uplink symbols capable of being scheduled or transmitted of the terminal, a maximum quantity of uplink slots capable of being scheduled or transmitted of the terminal, a maximum percentage of uplink duration capable of being scheduled or transmitted of the terminal, a maximum percentage of uplink slot capable of being scheduled or transmitted of the terminal, a maximum percentage of uplink sub-frame capable of being scheduled or transmitted of the terminal and a maximum percentage of uplink symbol capable of being scheduled or transmitted of the terminal in the first time window; and

first time window configuration information configured to indicate a duration of a first time window.

Optionally, the transceiver 810 is further configured to:

send the first indication information to the terminal through broadcast information; or

send the first indication information to the terminal through a dedicated signaling.

Optionally, the transceiver 810 is further configured to:

send the first indication information to the terminal at a first working frequency band where the network device works.

Optionally, the first time window includes at least one frame structure period; or

the first time window includes at least one slot; or

the first time window includes at least one sub-frame; or,

the first time window includes at least one symbol; or

the first time window includes at least one millisecond.

Optionally, the first time window is a predefined evaluation period;

the first time window is a time reference for the terminal to evaluate whether the applicable electromagnetic power density exposure requirement or the electromagnetic radiation specific absorption ratio requirement limit is met; or

the first time window is a time range of a maximum available uplink resource of the terminal in a case that the terminal evaluates that the applicable electromagnetic power density exposure requirement or the electromagnetic radiation specific absorption ratio requirement limit is met; or

the first time window is a time range of a maximum available output power configurable by the terminal in the case that the terminal evaluates that the applicable electromagnetic power density exposure requirement or the electromagnetic radiation specific absorption ratio requirement limit is met.

Optionally, the transceiver 810 is further configured to acquire second indication information reported by the terminal,

where the second indication information includes at least one of:

available uplink and downlink configuration information of the terminal, in a case of ensuring compliance with applicable electromagnetic power density exposure requirement or the electromagnetic radiation specific absorption ratio requirement limit;

in a case of ensuring compliance with applicable electromagnetic power density exposure requirement or the electromagnetic radiation specific absorption ratio requirement limit, at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window;

in a case that the current uplink and downlink configuration of the network device is applied, a maximum available output power configurable by the terminal in a case of ensuring compliance with applicable electromagnetic power density exposure requirement or the electromagnetic radiation specific absorption ratio requirement limit;

first power class information of the terminal at a first working frequency band where the network device works; and

the maximum available output powers configurable by the terminal corresponding to different uplink and downlink configurations, in the case that the applicable electromagnetic power density exposure requirement or the electromagnetic radiation specific absorption ratio requirement limit is met.

Optionally, the transceiver 810 is further configured to: prior to acquiring the second indication information, acquire second power class information of the terminal at the first working frequency band where the network device works;

where a transmitting power corresponding to the second power class information is larger than a transmitting power corresponding to the first power class information.

Optionally, the processor 800 is further configured to:

in a case that a current uplink and downlink configuration of the network device is applied, determine a maximum available output power configurable by the terminal in a case of ensuring compliance with applicable electromagnetic power density exposure requirement or the electromagnetic radiation specific absorption ratio requirement limit; or

in the case that the current uplink and downlink configuration of the network device is applied, determine at least one of a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal; or

determine first power class information of the terminal at a first working frequency band where the network device works; or

determine a maximum available output power configurable by the terminal in the first time window; or

determine at least one of a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window.

Optionally, the processor 800 is further configured to:

determine the maximum available output power configurable by the terminal in the first time window, according to the second indication information reported by the terminal; or

determine the first power class information of the terminal at a first working frequency band where the network device works, according to the second indication information reported by the terminal; or

determine, according to the second indication information reported by the terminal, at least one of the maximum uplink duration capable of being scheduled or transmitted of the terminal, the maximum quantity of uplink slots capable of being scheduled or transmitted of the terminal, the maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window.

Optionally, the processor 800 is further configured to:

perform an uplink resource scheduling or uplink transmission for the terminal;

where a duration of scheduled or transmitted resource is less than or equal to a maximum uplink duration capable of being scheduled or transmitted of the terminal; or

a quantity of slots of the scheduled or transmitted resource is less than or equal to a maximum quantity of uplink slots capable of being scheduled or transmitted of the terminal; or

a quantity of uplink sub-frames of the scheduled or transmitted resource is less than or equal to a maximum quantity of uplink sub-frames capable of being scheduled or transmitted of the terminal; or

a quantity of uplink symbols of the scheduled or transmitted resource is less than or equal to a maximum quantity of uplink symbols capable of being scheduled or transmitted of the terminal; or

an uplink duration percentage of the scheduled or transmitted resource is less than or equal to a maximum percentage of uplink duration capable of being scheduled or transmitted of the terminal; or

an uplink slot percentage of the scheduled or transmitted resource is less than or equal to a maximum percentage of uplink slot capable of being scheduled or transmitted of the terminal; or

an uplink sub-frame percentage of the scheduled or transmitted resource is less than or equal to a maximum percentage of uplink sub-frame capable of being scheduled or transmitted of the terminal; or

an uplink symbol percentage of the scheduled or transmitted resource is less than or equal to a maximum percentage of uplink symbol capable of being scheduled or transmitted of the terminal.

Optionally, the processor 800 is further configured to:

send a power adjustment value to the terminal; where

in a case that the power adjustment value is applied to the terminal, a transmitting power of the terminal is less than or equal to a maximum available output power configurable by the terminal; or

in the case that the power adjustment value is applied to the terminal, the transmitting power of the terminal is less than or equal to a transmitting power value corresponding to a first power class of the terminal at a first working frequency band; or

in the case that the power adjustment value is applied to the terminal, the transmitting power of the terminal is less than or equal to the maximum available output power configurable by the terminal in a case that the current uplink and downlink configuration of the network device is applied.

In summary, according to the above embodiments of the present disclosure, the network device sends first indication information to the terminal, and the network device or the terminal may adjust the power or resources of the terminal in a case that the regional SAR limit requirements are satisfied, without restricting the uplink resource configuration of the high-power terminal, so that the high-power terminal may be used in more scenarios.

It should be noted that the network device provided in the embodiments of the present disclosure is a network device capable of executing the above information transmission method, and all the embodiments of the above information transmission method are applicable to the network device, and can achieve the same or similar beneficial effects.

An information transmission device is further provided in an embodiment of the present disclosure, which is applied to network device, including:

a first sending module, configured to send first indication information to a terminal, where the first indication information includes at least one of:

location area identity information of the network device;

information of current uplink and downlink configuration of the network device;

specific absorption ratio limit information, including: an applicable electromagnetic power density exposure requirement, an electromagnetic radiation specific absorption ratio requirement limit, an applicable electromagnetic power density exposure requirement identity or an electromagnetic radiation specific absorption ratio requirement limit identity;

uplink resource control information, including at least one of: a quantity of uplink time domain resources, a quantity of uplink symbols, a quantity of uplink slots, an uplink symbol duty ratio, an uplink slot duty ratio, a maximum quantity of available uplink time domain resources of the terminal, a maximum quantity of available uplink symbols of the terminal, a maximum quantity of available uplink slots of the terminal, a maximum available uplink symbol duty ratio of the terminal, a maximum uplink slot duty ratio of the terminal, a maximum quantity of uplink time domain resources capable of being scheduled or transmitted of the terminal, a maximum quantity of uplink symbols capable of being scheduled or transmitted of the terminal, a maximum quantity of uplink slots capable of being scheduled or transmitted of the terminal, a maximum percentage of uplink duration capable of being scheduled or transmitted of the terminal, a maximum percentage of uplink slot capable of being scheduled or transmitted of the terminal, a maximum percentage of uplink sub-frame capable of being scheduled or transmitted of the terminal and a maximum percentage of uplink symbol capable of being scheduled or transmitted of the terminal in the first time window; and

first time window configuration information configured to indicate a duration of a first time window.

In summary, according to the above embodiments of the present disclosure, the network device sends first indication information to the terminal, and the network device or the terminal may adjust the power or resources of the terminal in a case that the regional SAR limit requirements are satisfied, without restricting the uplink resource configuration of the high-power terminal, so that the high-power terminal may be used in more scenarios.

It should be noted that the information transmission device provided in the embodiments of the present disclosure is an information transmission device capable of executing the above information transmission method, and all the embodiments of the above information transmission method are applicable to the information transmission device, and can achieve the same or similar beneficial effects.

As shown in FIG. 9, a terminal is further provided in an embodiment of the present disclosure, including a processor 900 and a transceiver 910, the terminal also includes a user interface 920, and the processor 900 is configured to control the transceiver 910 to:

receive first indication information sent by a network device, where the first indication information includes at least one of:

location area identity information of the network device;

information of current uplink and downlink configuration of the network device;

specific absorption ratio limit information, including: an applicable electromagnetic power density exposure requirement, an electromagnetic radiation specific absorption ratio requirement limit, an applicable electromagnetic power density exposure requirement identity or an electromagnetic radiation specific absorption ratio requirement limit identity;

uplink resource control information, including at least one of: a quantity of uplink time domain resources, a quantity of uplink symbols, a quantity of uplink slots, an uplink symbol duty ratio, an uplink slot duty ratio, a maximum quantity of available uplink time domain resources of the terminal, a maximum quantity of available uplink symbols of the terminal, a maximum quantity of available uplink slots of the terminal, a maximum available uplink symbol duty ratio of the terminal, a maximum uplink slot duty ratio of the terminal, a maximum quantity of uplink time domain resources capable of being scheduled or transmitted of the terminal, a maximum quantity of uplink symbols capable of being scheduled or transmitted of the terminal, a maximum quantity of uplink slots capable of being scheduled or transmitted of the terminal, a maximum percentage of uplink duration capable of being scheduled or transmitted of the terminal, a maximum percentage of uplink slot capable of being scheduled or transmitted of the terminal, a maximum percentage of uplink sub-frame capable of being scheduled or transmitted of the terminal and a maximum percentage of uplink symbol capable of being scheduled or transmitted of the terminal in the first time window; and

first time window configuration information configured to indicate a duration of a first time window.

Optionally, the transceiver 910 is further configured to:

receive the first indication information of the network device sent by the network device through broadcast information; or

receive the first indication information of the network device sent by the network device through a dedicated signaling.

Optionally, the transceiver 910 is further configured to:

receive the first indication information which is sent by the network device at a first working frequency band where the network device works.

Optionally, the first time window includes at least one frame structure period; or

the first time window includes at least one slot; or

the first time window includes at least one sub-frame; or,

the first time window includes at least one symbol; or

the first time window includes at least one millisecond.

Optionally, the first time window is a predefined evaluation period;

the first time window is a time range for the terminal to evaluate whether the applicable electromagnetic power density exposure requirement or the electromagnetic radiation specific absorption ratio requirement limit is met; or

the first time window is a time range of a maximum available uplink resource of the terminal in a case that the terminal evaluates that the applicable electromagnetic power density exposure requirement or the electromagnetic radiation specific absorption ratio requirement limit is met; or

the first time window is a time range of a maximum available output power configurable by the terminal in the case that the terminal evaluates that the applicable electromagnetic power density exposure requirement or the electromagnetic radiation specific absorption ratio requirement limit is met.

Optionally, the processor 900 is further configured to:

control the transceiver to report second indication information to the network device,

where the second indication information includes at least one of:

available uplink and downlink configuration information of the terminal, in a case of ensuring compliance with applicable electromagnetic power density exposure requirement or the electromagnetic radiation specific absorption ratio requirement limit;

at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window;

in a case that the current uplink and downlink configuration of the network device is applied, a maximum available output power configurable by the terminal in a case of ensuring compliance with applicable electromagnetic power density exposure requirement or the electromagnetic radiation specific absorption ratio requirement limit;

first power class information of the terminal at a first working frequency band where the network device works; and

maximum available output powers configurable by the terminal corresponding to different uplink and downlink configurations, in the case that the applicable electromagnetic power density exposure requirement or the electromagnetic radiation specific absorption ratio requirement limit is met.

Optionally, the transceiver 910 is further configured to:

prior to reporting the second indication information to the network device, send, to the network device, second power class information of the terminal at the first working frequency band where the network device works;

where a transmitting power corresponding to the second power class information is larger than a transmitting power corresponding to the first power class information.

Optionally, in a case that the first indication information includes the location area identity information of the network device, the processor 900 is further configured to:

determine, according to a country identity in the location area identity information of the network device, a country where the network device is located, and acquire the applicable electromagnetic power density exposure requirement or the electromagnetic radiation specific absorption ratio requirement limit corresponding to the country; or

determine, according to a country identity and an operator identity in the location area identity information of the network device, a country and an operator where the network device is located, and acquire the applicable electromagnetic power density exposure requirement or the electromagnetic radiation specific absorption ratio requirement limit corresponding to the country and the operator.

Optionally, the transceiver 910 is further configured to:

in a case that a second power class of the terminal at the first working frequency band where the network device works does not meet the applicable electromagnetic power density exposure requirement or the electromagnetic radiation specific absorption ratio requirement limit, send the second indication information to the network device; or

in a case that the terminal with the current uplink and downlink configuration of the network device does not meet the applicable electromagnetic power density exposure requirement or the electromagnetic radiation specific absorption ratio requirement limit, send the second indication information to the network device; or

in a case that a duration of scheduled or transmitted resource of the terminal is greater than the maximum uplink duration capable of being scheduled or transmitted of the terminal in the first time window, send the second indication information to the network device; or

in a case that a quantity of slots of scheduled or transmitted resource of the terminal is greater than the maximum quantity of uplink slots capable of being scheduled or transmitted of the terminal in the first time window, send the second indication information to the network device; or

in a case that a quantity of uplink sub-frames of scheduled or transmitted resource of the terminal is greater than the maximum quantity of uplink sub-frames capable of being scheduled or transmitted of the terminal in the first time window, send the second indication information to the network device; or

in a case that a quantity of uplink symbols of scheduled or transmitted resource of the terminal is greater than the maximum quantity of uplink symbols capable of being scheduled or transmitted of the terminal in the first time window, send the second indication information to the network device; or

in a case that an uplink duration percentage of scheduled or transmitted resource of the terminal is greater than the maximum percentage of uplink duration capable of being scheduled or transmitted of the terminal in the first time window, send the second indication information to the network device; or

in a case that an uplink slot percentage of scheduled or transmitted resource of the terminal is greater than the maximum percentage of uplink slot capable of being scheduled or transmitted of the terminal in the first time window, send the second indication information to the network device; or

in a case that an uplink sub-frame percentage of scheduled or transmitted resource of the terminal is greater than the maximum percentage of uplink sub-frame capable of being scheduled or transmitted of the terminal in the first time window, send the second indication information to the network device; or

in a case that an uplink symbol percentage of scheduled or transmitted resource of the terminal is greater than the maximum percentage of uplink symbol capable of being scheduled or transmitted of the terminal in the first time window, send the second indication information to the network device; or

send the second indication information to the network device according to the specific absorption ratio limit information.

Optionally, the processor 900 is further configured to:

determine, according to the first indication information, at least one of:

in a case of ensuring compliance with applicable electromagnetic power density exposure requirement or the electromagnetic radiation specific absorption ratio requirement limit, at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal;

in a case that the current uplink and downlink configuration of the network device is applied, a maximum available output power configurable by the terminal in a case of ensuring compliance with applicable electromagnetic power density exposure requirement or the electromagnetic radiation specific absorption ratio requirement limit; and

the maximum available output powers configurable by the terminal in different uplink and downlink configurations, in the case that the applicable electromagnetic power density exposure requirement or the electromagnetic radiation specific absorption ratio requirement limit is met.

Optionally, the processor 900 is further configured to:

reconfigure a maximum available output power of the terminal, or controlling the terminal to perform a power back-off, or prohibit a transmission of at least one piece of uplink information of the terminal; where the uplink information includes: an uplink slot, or an uplink sub-frame, or an uplink symbol.

Optionally, the processor 900 is further configured to:

determine the maximum available output power configurable by the terminal according to the first indication information, or determine the maximum available output power configurable by the terminal in a case that the current uplink and downlink configuration of the network device is applied;

in a case that a power of the terminal configured by a network device power control is greater than the maximum available output power configurable by the terminal, perform the power back-off, and controlling the power of the control terminal to back to be less than or equal to the maximum available output power configurable by the terminal.

Optionally, a back-off value of the power back-off is equal to the power configured for the terminal by the network device minus the maximum available output power configurable by the terminal.

Optionally, the processor 900 is further configured to:

in a case of ensuring compliance with applicable electromagnetic power density exposure requirement or the electromagnetic radiation specific absorption ratio requirement limit, determine, according to the first indication information, at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal;

in a case that an uplink duration scheduled by the network device for the terminal is greater than the maximum uplink duration capable of being scheduled or transmitted of the terminal or in a case that an uplink duration percentage scheduled by the network device for the terminal is greater than the maximum percentage of uplink duration capable of being scheduled or transmitted of the terminal, prohibit a data transmission on at least one uplink time unit; or

in a case that a resource quantity of uplink slots scheduled by the network device for the terminal is greater than a maximum resource quantity of uplink slots capable of being scheduled or transmitted of the terminal or in a case that an uplink slot percentage scheduled by the network device for the terminal is greater than the maximum percentage of uplink slot capable of being scheduled or transmitted of the terminal, prohibit a data transmission on a resource of at least one uplink slot; or

in a case that a resource quantity of uplink sub-frames scheduled by the network device for the terminal is greater than the maximum quantity of uplink sub-frames capable of being scheduled or transmitted of the terminal or in a case that an uplink sub-frame percentage scheduled by the network device for the terminal is greater than the maximum percentage of uplink sub-frame capable of being scheduled or transmitted of the terminal, prohibit a data transmission on a resource of at least one uplink sub-frame; or

in a case that a resource quantity of uplink symbols scheduled by the network device for the terminal is greater than the maximum quantity of uplink symbols capable of being scheduled or transmitted of the terminal or in a case that an uplink symbol percentage scheduled by the network device for the terminal is greater than the maximum percentage of uplink symbol capable of being scheduled or transmitted of the terminal, prohibit a data transmission on a resource of at least one uplink symbol.

Optionally, the processor 900 is further configured to:

in a case that a duration of scheduled or transmitted resource of the terminal is greater than the maximum uplink duration capable of being scheduled or transmitted of the terminal in the first time window, reconfigure a maximum available output power of the terminal or performing a power back-off by the terminal; or

in a case that a quantity of slots of scheduled or transmitted resource of the terminal is greater than the maximum quantity of uplink slots capable of being scheduled or transmitted of the terminal in the first time window, reconfigure a maximum available output power of the terminal or performing a power back-off by the terminal; or

in a case that a quantity of uplink sub-frames of scheduled or transmitted resource of the terminal is greater than the maximum quantity of uplink sub-frames capable of being scheduled or transmitted of the terminal in the first time window, reconfigure a maximum available output power of the terminal or performing a power back-off by the terminal; or

in a case that a quantity of uplink symbols of scheduled or transmitted resource of the terminal is greater than the maximum quantity of uplink symbols capable of being scheduled or transmitted of the terminal in the first time window, reconfigure a maximum available output power of the terminal or performing a power back-off by the terminal; or

in a case that an uplink duration percentage of scheduled or transmitted resource of the terminal is greater than the maximum percentage of uplink duration capable of being scheduled or transmitted of the terminal in the first time window, reconfigure a maximum available output power of the terminal or performing a power back-off by the terminal; or

in a case that an uplink slot percentage of scheduled or transmitted resource of the terminal is greater than the maximum percentage of uplink slot capable of being scheduled or transmitted of the terminal in the first time window, reconfigure a maximum available output power of the terminal or performing a power back-off by the terminal; or

in a case that an uplink sub-frame percentage of scheduled or transmitted resource of the terminal is greater than the maximum percentage of uplink sub-frame capable of being scheduled or transmitted of the terminal in the first time window, reconfigure a maximum available output power of the terminal or performing a power back-off by the terminal; or

in a case that an uplink symbol percentage of scheduled or transmitted resource of the terminal is greater than the maximum percentage of uplink symbol capable of being scheduled or transmitted of the terminal in the first time window, reconfigure a maximum available output power of the terminal or performing a power back-off by the terminal.

Optionally, one or more of the maximum uplink duration capable of being scheduled or transmitted of the terminal, the maximum quantity of uplink slots capable of being scheduled or transmitted of the terminal, the maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal is determined by the terminal according to uplink resource control information in the first indication information; or

one or more of the maximum uplink duration capable of being scheduled or transmitted of the terminal, the maximum quantity of uplink slots capable of being scheduled or transmitted of the terminal, the maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal is predefined in a criterion.

Optionally, the processor 900 is further configured to:

report a reconfigured maximum available output power of the terminal to the network device; or

in a case that scheduled uplink resource of the terminal in the first time window exceeds a first threshold, after the terminal performs the power back-off, a power value of the terminal is less than or equal to a maximum available output power configurable by the terminal.

Optionally, the processor 900 is further configured to:

in a case that an uplink symbol percentage scheduled or transmitted by the terminal in the first time window is greater than a capability of the terminal corresponding to the second indication information, apply all requirements for the first power class to the supported power class.

Optionally, the processor 900 is further configured to:

in a case that an uplink symbol percentage scheduled or transmitted by the terminal in the first time window is greater than a capability of the terminal corresponding to the second indication information, lower a lower limit of a maximum transmitting power configuration value of the terminal.

To sum up, according to the above embodiments of the present disclosure, after receiving the first indication information, the terminal may reconfigure the maximum available output power of the terminal based on the first indication information or control the terminal to perform the power back-off or prohibit the transmission of at least one uplink information of the terminal; or after receiving the first indication information, the terminal sends second indication information to the network device based on the first indication information, and the network device may perform the resource scheduling and/or power adjustment on the terminal based on the second indication information. That is, the network device or terminal may adjust the power or resources of the terminal while ensuring that the regional SAR limit requirement is met, without restricting the uplink resource configuration of the high-power terminal, so that the high-power terminal may be used in more scenarios.

It should be noted that the terminal provided in the embodiments of the present disclosure is a terminal capable of executing the above information transmission method, so all embodiments of the above information transmission method are applicable to the terminal and can achieve the same or similar beneficial effects.

An information transmission device applied to a terminal is further provided in an embodiment of the present disclosure, where the information transmission includes:

a first receiving module, configured to receive first indication information sent by a network device, where the first indication information includes at least one of:

location area identity information of the network device;

information of current uplink and downlink configuration of the network device;

specific absorption ratio limit information, including: an applicable electromagnetic power density exposure requirement, an electromagnetic radiation specific absorption ratio requirement limit, an applicable electromagnetic power density exposure requirement identity or an electromagnetic radiation specific absorption ratio requirement limit identity;

uplink resource control information, including at least one of: a quantity of uplink time domain resources, a quantity of uplink symbols, a quantity of uplink slots, an uplink symbol duty ratio, an uplink slot duty ratio, a maximum quantity of available uplink time domain resources of the terminal, a maximum quantity of available uplink symbols of the terminal, a maximum quantity of available uplink slots of the terminal, a maximum available uplink symbol duty ratio of the terminal, a maximum uplink slot duty ratio of the terminal, a maximum quantity of uplink time domain resources capable of being scheduled or transmitted of the terminal, a maximum quantity of uplink symbols capable of being scheduled or transmitted of the terminal, a maximum quantity of uplink slots capable of being scheduled or transmitted of the terminal, a maximum percentage of uplink duration capable of being scheduled or transmitted of the terminal, a maximum percentage of uplink slot capable of being scheduled or transmitted of the terminal, a maximum percentage of uplink sub-frame capable of being scheduled or transmitted of the terminal and a maximum percentage of uplink symbol capable of being scheduled or transmitted of the terminal in the first time window; and

first time window configuration information configured to indicate a duration of a first time window.

To sum up, according to the above embodiments of the present disclosure, after receiving the first indication information, the terminal may reconfigure the maximum available output power of the terminal based on the first indication information or control the terminal to perform the power back-off or prohibit the transmission of at least one uplink information of the terminal; or after receiving the first indication information, the terminal sends second indication information to the network device based on the first indication information, and the network device may perform the resource scheduling and/or power adjustment on the terminal based on the second indication information. That is, the network device or terminal may adjust the power or resources of the terminal while ensuring that the regional SAR limit requirement is met, without restricting the uplink resource configuration of the high-power terminal, so that the high-power terminal may be used in more scenarios.

It should be noted that the information transmission device provided in the embodiments of the present disclosure is an information transmission device capable of executing the above information transmission method, so all the embodiments of the above information transmission method are applicable to the information transmission device, and can achieve the same or similar beneficial effects.

As shown in FIG. 9, a terminal is further provided in an embodiment of the present disclosure, including a processor 900 and a transceiver 910, the terminal also includes a user interface 920, and the processor 900 is configured to control the transceiver 910 to:

send second indication information to a network device,

where the second indication information includes at least one of:

available uplink and downlink configuration information of the terminal, in a case of ensuring compliance with applicable electromagnetic power density exposure requirement or the electromagnetic radiation specific absorption ratio requirement limit;

in a case of ensuring compliance with applicable electromagnetic power density exposure requirement or the electromagnetic radiation specific absorption ratio requirement limit, at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window;

in a case that the current uplink and downlink configuration of the network device is applied, a maximum available output power configurable by the terminal in a case of ensuring compliance with applicable electromagnetic power density exposure requirement or the electromagnetic radiation specific absorption ratio requirement limit;

first power class information of the terminal at a first working frequency band where the network device works; and

the maximum available output powers configurable by the terminal corresponding to different uplink and downlink configurations, in the case that the applicable electromagnetic power density exposure requirement or the electromagnetic radiation specific absorption ratio requirement limit is met.

Optionally, the first time window includes at least one frame structure period; or

the first time window includes at least one slot; or

the first time window includes at least one sub-frame; or,

the first time window includes at least one symbol; or

the first time window includes at least one millisecond.

Optionally, the first time window is a predefined evaluation period;

the first time window is a time range for the terminal to evaluate whether the applicable electromagnetic power density exposure requirement or the electromagnetic radiation specific absorption ratio requirement limit is met; or

the first time window is a time range of a maximum available uplink resource of the terminal in a case that the terminal evaluates that the applicable electromagnetic power density exposure requirement or the electromagnetic radiation specific absorption ratio requirement limit is met; or

the first time window is a time range of a maximum available output power configurable by the terminal in the case that the terminal evaluates that the applicable electromagnetic power density exposure requirement or the electromagnetic radiation specific absorption ratio requirement limit is met.

Optionally, the transceiver 910 is further configured to:

prior to sending the second indication information to the network device, send, to the network device, second power class information of the terminal at the first working frequency band where the network device works;

where a transmitting power corresponding to the second power class information is larger than a transmitting power corresponding to the first power class information.

Optionally, the transceiver 910 is further configured to:

in a case that the current uplink and downlink configuration of the network device is applied and the terminal determines that the applicable electromagnetic power density exposure requirement or the electromagnetic radiation specific absorption ratio requirement limit is not met, send, to the network device, the second power class information of the terminal at the first working frequency band where the network device works.

Optionally, the transceiver 910 is further configured to: report a power headroom, where the power headroom is based on the maximum available output power configurable by the terminal in a case of ensuring compliance with applicable electromagnetic power density exposure requirement or the electromagnetic radiation specific absorption ratio requirement limit.

Optionally, the processor 900 is further configured to:

in a case that an uplink symbol percentage scheduled or transmitted by the terminal in the first time window is greater than a capability of the terminal corresponding to the second indication information, apply all requirements for the first power class to the supported power class.

Optionally, the processor 900 is further configured to:

in a case that an uplink symbol percentage scheduled or transmitted by the terminal in the first time window is greater than a capability of the terminal corresponding to the second indication information, lower a lower limit of a maximum transmitting power configuration value of the terminal.

To sum up, according to the above embodiments of the present disclosure, the terminal actively reports the second indication information (equivalent to the capability information of the terminal) to the network device, and the network device may, according to the second indication information reported by the terminal, adjust the power or resources of the terminal in a case that the regional SAR value requirements are satisfied, without restricting the uplink resource configuration of the high-power terminal, so that the high-power terminal may be used in more scenarios.

It should be noted that the terminal provided in the embodiments of the present disclosure is a terminal capable of executing the above information transmission method, and all the embodiments of the above information transmission method are applicable to the terminal and can achieve the same or similar beneficial effects.

An information transmission device applied to a terminal is further provided in an embodiment of the present disclosure, including:

a second sending module, configured to send second indication information to a network device,

where the second indication information includes at least one of:

available uplink and downlink configuration information of the terminal, in a case of ensuring compliance with applicable electromagnetic power density exposure requirement or the electromagnetic radiation specific absorption ratio requirement limit;

in a case of ensuring compliance with applicable electromagnetic power density exposure requirement or the electromagnetic radiation specific absorption ratio requirement limit, at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window;

in a case that the current uplink and downlink configuration of the network device is applied, a maximum available output power configurable by the terminal in a case of ensuring compliance with applicable electromagnetic power density exposure requirement or the electromagnetic radiation specific absorption ratio requirement limit;

first power class information of the terminal at a first working frequency band where the network device works; and

the maximum available output powers configurable by the terminal corresponding to different uplink and downlink configurations, in the case that the applicable electromagnetic power density exposure requirement or the electromagnetic radiation specific absorption ratio requirement limit is met.

To sum up, according to the above embodiments of the present disclosure, the terminal actively reports the second indication information (equivalent to the capability information of the terminal) to the network device, and the network device may, according to the second indication information reported by the terminal, adjust the power or resources of the terminal in a case that the regional SAR value requirements are satisfied, without restricting the uplink resource configuration of the high-power terminal, so that the high-power terminal may be used in more scenarios.

It should be noted that the information transmission device provided in the embodiments of the present disclosure is an information transmission device capable of executing the above information transmission method, and all the embodiments of the above information transmission method are applicable to the information transmission device, and all can achieve the same or similar beneficial effects.

As shown in FIG. 8, a network device is further provided in an embodiment of the present disclosure, including a processor 800 and a transceiver 810, and the processor 800 is configured to control the transceiver 810 to:

receive second indication information sent by a terminal,

where the second indication information includes at least one of:

available uplink and downlink configuration information of the terminal, in a case of ensuring compliance with applicable electromagnetic power density exposure requirement or the electromagnetic radiation specific absorption ratio requirement limit;

in a case of ensuring compliance with applicable electromagnetic power density exposure requirement or the electromagnetic radiation specific absorption ratio requirement limit, at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window;

in a case that the current uplink and downlink configuration of the network device is applied, a maximum available output power configurable by the terminal in a case of ensuring compliance with applicable electromagnetic power density exposure requirement or the electromagnetic radiation specific absorption ratio requirement limit;

first power class information of the terminal at a first working frequency band where the network device works; and

the maximum available output powers configurable by the terminal corresponding to different uplink and downlink configurations, in the case that the applicable electromagnetic power density exposure requirement or the electromagnetic radiation specific absorption ratio requirement limit is met.

Optionally, the first time window includes at least one frame structure period; or

the first time window includes at least one slot; or

the first time window includes at least one sub-frame; or,

the first time window includes at least one symbol; or

the first time window includes at least one millisecond.

Optionally, the first time window is a predefined evaluation period;

the first time window is a time range for the terminal to evaluate whether the applicable electromagnetic power density exposure requirement or the electromagnetic radiation specific absorption ratio requirement limit is met; or

the first time window is a time range of a maximum available uplink resource of the terminal in a case that the terminal evaluates that the applicable electromagnetic power density exposure requirement or the electromagnetic radiation specific absorption ratio requirement limit is met; or

the first time window is a time range of a maximum available output power configurable by the terminal in the case that the terminal evaluates that the applicable electromagnetic power density exposure requirement or the electromagnetic radiation specific absorption ratio requirement limit is met.

Optionally, the transceiver 810 is further configured to:

prior to receiving the second indication information sent by the terminal, receive second power class information of the terminal at the first working frequency band where the network device works which is sent by the terminal;

where a transmitting power corresponding to the second power class information is larger than a transmitting power corresponding to the first power class information.

Optionally, the transceiver 810 is further configured to:

in a case that the current uplink and downlink configuration of the network device is applied and the terminal determines that the applicable electromagnetic power density exposure requirement or the electromagnetic radiation specific absorption ratio requirement limit is not met, receive the second power class information of the terminal at the first working frequency band where the network device works which is sent by the terminal.

Optionally, the transceiver 810 is further configured to: receive a power headroom reported by the terminal, where the power headroom is based on the maximum available output power configurable by the terminal in a case of ensuring compliance with applicable electromagnetic power density exposure requirement or the electromagnetic radiation specific absorption ratio requirement limit.

Optionally, the processor 800 is further configured to:

perform an uplink resource scheduling or an uplink transmission for the terminal;

a duration of scheduled or transmitted resource is less than or equal to the maximum uplink duration capable of being scheduled or transmitted of the terminal in the first time window; or

a quantity of slots of scheduled or transmitted resource is less than or equal to the maximum quantity of uplink slots capable of being scheduled or transmitted of the terminal in the first time window; or

a quantity of uplink sub-frames of scheduled or transmitted resource is less than or equal to the maximum quantity of uplink sub-frames capable of being scheduled or transmitted of the terminal in the first time window; or

a quantity of uplink symbols of scheduled or transmitted resource is less than or equal to the maximum quantity of uplink symbols capable of being scheduled or transmitted of the terminal in the first time window; or

an uplink duration percentage of scheduled or transmitted resource is less than or equal to the maximum percentage of uplink duration capable of being scheduled or transmitted of the terminal in the first time window; or

an uplink slot percentage of scheduled or transmitted resource is less than or equal to the maximum percentage of uplink slot capable of being scheduled or transmitted of the terminal in the first time window; or

an uplink sub-frame percentage of scheduled or transmitted resource is less than or equal to the maximum percentage of uplink sub-frame capable of being scheduled or transmitted of the terminal in the first time window; or

an uplink symbol percentage of scheduled or transmitted resource is less than or equal to the maximum percentage of uplink symbol capable of being scheduled or transmitted of the terminal in the first time window.

Optionally, the processor 800 is further configured to:

send a power adjustment value to the terminal; where

in a case that the power adjustment value is applied to the terminal, a transmitting power of the terminal is less than or equal to a maximum available output power configurable by the terminal; or

in the case that the power adjustment value is applied to the terminal, the transmitting power of the terminal is less than or equal to a transmitting power value corresponding to a first power class of the terminal at a first working frequency band; or

in the case that the power adjustment value is applied to the terminal, the transmitting power of the terminal is less than or equal to the maximum available output power configurable by the terminal in a case that the current uplink and downlink configuration of the network device is applied.

To sum up, according to the above embodiments of the present disclosure, the terminal actively reports the second indication information to the network device, and the network device may, according to the second indication information reported by the terminal, adjust the power or resources of the terminal in a case that the regional SAR value requirements are satisfied, without restricting the uplink resource configuration of the high-power terminal, so that the high-power terminal may be used in more scenarios.

It should be noted that the network device provided in the embodiments of the present disclosure is a network device capable of executing the above information transmission method, so all embodiments of the above information transmission method are applicable to the network device, and can achieve the same or similar benefits effect.

An information transmission method applied to a terminal is further provided in an embodiment of the present disclosure, including: sending second indication information to a network device,

where the second indication information includes at least one of:

available uplink and downlink configuration information of the terminal (available uplink and downlink slot configuration information of the terminal or available uplink and downlink sub-frame configuration information of the terminal), in a case of ensuring compliance with applicable electromagnetic power density exposure requirement or the electromagnetic radiation specific absorption ratio requirement limit;

in a case of ensuring compliance with applicable electromagnetic power density exposure requirement or the electromagnetic radiation specific absorption ratio requirement limit, at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window;

in a case that the current uplink and downlink configuration of the network device is applied, a maximum available output power configurable by the terminal in a case of ensuring compliance with applicable electromagnetic power density exposure requirement or the electromagnetic radiation specific absorption ratio requirement limit;

first power class information of the terminal at a first working frequency band where the network device works; and

the maximum available output powers configurable by the terminal corresponding to different uplink and downlink configurations, in the case that the applicable electromagnetic power density exposure requirement or the electromagnetic radiation specific absorption ratio requirement limit is met.

Optionally, in the above embodiment of the present disclosure, the first time window includes: the first time window includes at least one frame structure period; or the first time window includes at least one slot; or the first time window includes at least one sub-frame; or the first time window includes at least one symbol; or the first time window includes at least one millisecond.

Further, in the above embodiments of the present disclosure, the method further includes:

prior to sending the second indication information to the network device, sending, to the network device, second power class information of the terminal at the first working frequency band where the network device works;

where a transmitting power corresponding to the second power class information is larger than a transmitting power corresponding to the first power class information.

For example, the terminal supports band 41 power class 2 26 dBm operation, i.e., the second power class, and the first power class is a default power class of the terminal (e.g., the maximum transmitting power is 23 dBm).

Optionally, the method further includes:

in a case that an uplink symbol percentage scheduled or transmitted by the terminal in the first time window is greater than a capability of the terminal corresponding to the second indication information, the terminal applying all requirements for the first power class to the supported power class.

Optionally, the method further includes:

in a case that an uplink symbol percentage scheduled or transmitted by the terminal in the first time window is greater than a capability of the terminal corresponding to the second indication information, the terminal lowering a lower limit of a maximum transmitting power permitted to be configured.

To sum up, according to the above embodiments of the present disclosure, the terminal actively reports the second indication information (equivalent to the capability information of the terminal) to the network device, and the network device may, according to the second indication information, schedule reasonably the power or uplink scheduling or transmission resource of the terminal in a case that the regional SAR value requirements are satisfied; or in a case that the scheduled or transmitted uplink resources of the terminal exceed the maximum capacity of the terminal to be scheduled or transmitted to meet the SAR value requirements, the terminal uses the index requirements of a low power class or a default power class; or the terminal lowers a lower limit of a maximum transmitting power configured by the terminal, so as to prevent the terminal from not complying with the SAR value requirements of the regulatory agency under special conditions

It should be noted that the information transmission device provided in the embodiments of the present disclosure is an information transmission device capable of executing the above information transmission method, so all the embodiments of the above information transmission method are applicable to the information transmission device, and can achieve the same or similar beneficial effects.

A computer-readable storage medium is further provided in an embodiment of the present disclosure, where a computer program is in the computer-readable storage medium. A processor executes the computer program to perform each process in the embodiment of the information transmission method applied to a network device or executes the computer program to perform each process in the embodiment of the information transmission method applied to a terminal, and the same technical effect can be achieved. To avoid repetition, details thereof are not described here. The computer-readable storage medium, such as read-only memory (Read-Only Memory, ROM), random access memory (Random Access Memory, RAM), magnetic disk, or optical disk, etc.

Those skilled in the art should understand that the embodiments of the present application can be provided as methods, systems or computer program products. Therefore, the present disclosure may adopt the form of a complete hardware embodiment, a complete software embodiment, or an embodiment combining software and hardware. Moreover, the present disclosure may adopt the form of a computer program product implemented on one or more computer-readable storage media (including but not limited to disk storage, optical storage, etc.) containing computer-usable program codes.

The present disclosure is described with reference to flowcharts and/or block diagrams of methods, equipment (systems) and computer program products according to the embodiments of the present disclosure. It should be understood that each process and/or block in the flowchart and/or block diagram, and the combination of processes and/or blocks in the flowchart and/or block diagram can be implemented by computer program instructions. These computer program instructions can be provided to the processor of a general-purpose computer, a special-purpose computer, an embedded processor, or other programmable data processing equipment to generate a machine, so that the instructions executed by the processor of the computer or other programmable data processing equipment are generated for use. It is a device that realizes the functions specified in one process or multiple processes and/or one block or multiple blocks in the flowchart.

These computer program instructions can also be stored in a computer-readable storage medium that can guide a computer or other programmable data processing equipment to work in a specific manner, so that the instructions stored in the computer-readable storage medium produce paper products including instruction devices, The instruction device realizes the functions specified in one process or multiple processes in the flowchart and/or one block or multiple blocks in the block diagram.

These computer program instructions can also be loaded on a computer or other programmable data processing equipment, so that the computer or other programmable equipment executes a series of operation steps to produce computer-implemented processing, thereby executing instructions on the computer or other scientific programming equipment Provides steps for realizing the functions specified in one process or multiple processes in the flowchart and/or one block or multiple blocks in the block diagram.

The above are some embodiments of the present disclosure. It should be noted that for those of ordinary skill in the art, without departing from the principles described in the present disclosure, several improvements and modifications can be made. These improvements and modifications should also be regarded as the scope of the present disclosure.

1. An information transmission method, applied to a network device, comprising:
sending first indication information to a terminal, wherein the first indication information comprises at least one of:
location area identity information of the network device;
information of uplink and downlink configuration of the network device;
specific absorption ratio limit information, comprising: an applicable electromagnetic power density exposure requirement, an electromagnetic radiation specific absorption ratio requirement limit, an applicable electromagnetic power density exposure requirement identity or an electromagnetic radiation specific absorption ratio requirement limit identity;
uplink resource control information, comprising at least one of: a quantity of uplink time domain resources, a quantity of uplink symbols, a quantity of uplink slots, an uplink symbol duty ratio, an uplink slot duty ratio, a maximum quantity of available uplink time domain resources of the terminal, a maximum quantity of available uplink symbols of the terminal, a maximum quantity of available uplink slots of the terminal, a maximum available uplink symbol duty ratio of the terminal, a maximum uplink slot duty ratio of the terminal, a maximum quantity of uplink time domain resources capable of being scheduled or transmitted of the terminal, a maximum quantity of uplink symbols capable of being scheduled or transmitted of the terminal, a maximum quantity of uplink slots capable of being scheduled or transmitted of the terminal, a maximum percentage of uplink duration capable of being scheduled or transmitted of the terminal, a maximum percentage of uplink slot capable of being scheduled or transmitted of the terminal, a maximum percentage of uplink sub-frame capable of being scheduled or transmitted of the terminal and a maximum percentage of uplink symbol capable of being scheduled or transmitted of the terminal in the first time window; and
first time window configuration information configured to indicate a duration of a first time window.

2. The method according to claim 1, wherein the sending the first indication information to the terminal comprises:
sending the first indication information to the terminal through broadcast information; or
sending the first indication information to the terminal through a dedicated signaling.

3. (canceled)

4. The method according to claim 1, wherein
the first time window comprises at least one frame structure period; or
the first time window comprises at least one slot; or
the first time window comprises at least one sub-frame; or,
the first time window comprises at least one symbol; or
the first time window comprises at least one millisecond.

5. The method according to claim 1, wherein
the first time window is a predefined evaluation period;
the first time window is a time reference for the terminal to evaluate whether the applicable electromagnetic power density exposure requirement or the electromagnetic radiation specific absorption ratio requirement limit is met; or
the first time window is a time range of a maximum available uplink resource of the terminal in a case that the terminal evaluates that the applicable electromagnetic power density exposure requirement or the electromagnetic radiation specific absorption ratio requirement limit is met; or
the first time window is a time range of a maximum available output power configurable by the terminal in the case that the terminal evaluates that the applicable electromagnetic power density exposure requirement or the electromagnetic radiation specific absorption ratio requirement limit is met.

6. The method according to claim 1, further comprising: acquiring second indication information reported by the terminal,
wherein the second indication information comprises at least one of:
available uplink and downlink configuration information of the terminal, in a case of ensuring compliance with applicable electromagnetic power density exposure requirement or the electromagnetic radiation specific absorption ratio requirement limit;
in a case of ensuring compliance with applicable electromagnetic power density exposure requirement or the electromagnetic radiation absorption ratio requirement limit, at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window;
in a case that the current uplink and downlink configuration of the network device is applied, a maximum available output power configurable by the terminal in a case of ensuring compliance with applicable electromagnetic power density exposure requirement or the electromagnetic radiation specific absorption ratio requirement limit;
first power class information of the terminal at a first working frequency band where the network device works; and
the maximum available output powers configurable by the terminal corresponding to different uplink and downlink configurations, in the case that the applicable electromagnetic power density exposure requirement or the electromagnetic radiation specific absorption ratio requirement limit is met.

7. The method according to claim 6, further comprising: prior to acquiring the second indication information, acquiring second power class information of the terminal at the first working frequency band where the network device works;
wherein a transmitting power corresponding to the second power class information is larger than a transmitting power corresponding to the first power class information;
or
the method further comprises:
determining the maximum available output power configurable by the terminal in the first time window, according to the second indication information reported by the terminal; or
determining the first power class information of the terminal at a first working frequency band where the network device works, according to the second indication information reported by the terminal; or
determining, according to the second indication information reported by the terminal, at least one of the maximum uplink duration capable of being scheduled or transmitted of the terminal, the maximum quantity of uplink slots capable of being scheduled or transmitted of the terminal, the maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window;
wherein the further comprises:
sending, by the network device, a power adjustment value to the terminal; wherein
in a case that the power adjustment value is applied to the terminal, a transmitting power of the terminal is less than or equal to a maximum available output power configurable by the terminal; or
in the case that the power adjustment value is applied to the terminal, the transmitting power of the terminal is less than or equal to a transmitting power value corresponding to a first power class of the terminal at a first working frequency band; or
in the case that the power adjustment value is applied to the terminal, the transmitting power of the terminal is less than or equal to the maximum available output power configurable by the terminal in a case that the current uplink and downlink configuration of the network device is applied.

8. The method according to claim 1, further comprising:
in a case that a current uplink and downlink configuration of the network device is applied, determining a maximum available output power configurable by the terminal in a case of ensuring compliance with applicable electromagnetic power density exposure requirement or the electromagnetic radiation specific absorption ratio requirement limit; or
in the case that the current uplink and downlink configuration of the network device is applied, determining at least one of a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal; or
determining first power class information of the terminal at a first working frequency band where the network device works; or
determining a maximum available output power configurable by the terminal in the first time window; or
determining at least one of a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window;
wherein the method further comprises:
the network device performing an uplink resource scheduling or uplink transmission for the terminal;
wherein a duration of scheduled or transmitted resource is less than or equal to a maximum uplink duration capable of being scheduled or transmitted of the terminal; or
a quantity of slots of the scheduled or transmitted resource is less than or equal to a maximum quantity of uplink slots capable of being scheduled or transmitted of the terminal; or
a quantity of uplink sub-frames of the scheduled or transmitted resource is less than or equal to a maximum quantity of uplink sub-frames capable of being scheduled or transmitted of the terminal; or
a quantity of uplink symbols of the scheduled or transmitted resource is less than or equal to a maximum quantity of uplink symbols capable of being scheduled or transmitted of the terminal; or
an uplink duration percentage of the scheduled or transmitted resource is less than or equal to a maximum percentage of uplink duration capable of being scheduled or transmitted of the terminal; or
an uplink slot percentage of the scheduled or transmitted resource is less than or equal to a maximum percentage of uplink slot capable of being scheduled or transmitted of the terminal; or
an uplink sub-frame percentage of the scheduled or transmitted resource is less than or equal to a maximum percentage of uplink sub-frame capable of being scheduled or transmitted of the terminal; or
an uplink symbol percentage of the scheduled or transmitted resource is less than or equal to a maximum percentage of uplink symbol capable of being scheduled or transmitted of the terminal.

9.-11. (canceled)

12. An information transmission method, applied to a terminal, comprising:
receiving first indication information sent by a network device, wherein the first indication information comprises at least one of:
location area identity information of the network device;
information of current uplink and downlink configuration of the network device;
specific absorption ratio limit information, comprising: an applicable electromagnetic power density exposure requirement, an electromagnetic radiation specific absorption ratio requirement limit, an applicable electromagnetic power density exposure requirement identity or an electromagnetic radiation specific absorption ratio requirement limit identity;
uplink resource control information, comprising at least one of: a quantity of uplink time domain resources, a quantity of uplink symbols, a quantity of uplink slots, an uplink symbol duty ratio, an uplink slot duty ratio, a maximum quantity of available uplink time domain resources of the terminal, a maximum quantity of available uplink symbols of the terminal, a maximum quantity of available uplink slots of the terminal, a maximum available uplink symbol duty ratio of the terminal, a maximum uplink slot duty ratio of the terminal, a maximum quantity of uplink time domain resources capable of being scheduled or transmitted of the terminal, a maximum quantity of uplink symbols capable of being scheduled or transmitted of the terminal, a maximum quantity of uplink slots capable of being scheduled or transmitted of the terminal, a maximum percentage of uplink duration capable of being scheduled or transmitted of the terminal, a maximum percentage of uplink slot capable of being scheduled or transmitted of the terminal, a maximum percentage of uplink sub-frame capable of being scheduled or transmitted of the terminal and a maximum percentage of uplink symbol capable of being scheduled or transmitted of the terminal in the first time window; and
first time window configuration information configured to indicate a duration of a first time window.

13. The method according to claim 12, wherein the receiving the first indication information sent by the network device comprises:
receiving the first indication information of the network device sent by the network device through broadcast information; or
receiving the first indication information of the network device sent by the network device through a dedicated signaling.

14. (canceled)

15. The method according to claim 12, wherein
the first time window comprises at least one frame structure period; or
the first time window comprises at least one slot; or
the first time window comprises at least one sub-frame; or,
the first time window comprises at least one symbol; or
the first time window comprises at least one millisecond.

16. The method according to claim 12, wherein
the first time window is a predefined evaluation period;
the first time window is a time range for the terminal to evaluate whether the applicable electromagnetic power density exposure requirement or the electromagnetic radiation specific absorption ratio requirement limit is met; or
the first time window is a time range of a maximum available uplink resource of the terminal in a case that the terminal evaluates that the applicable electromagnetic power density exposure requirement or the electromagnetic radiation specific absorption ratio requirement limit is met; or
the first time window is a time range of a maximum available output power configurable by the terminal in the case that the terminal evaluates that the applicable electromagnetic power density exposure requirement or the electromagnetic radiation specific absorption ratio requirement limit is met.

17. The method according to claim 12, further comprising:
reporting second indication information to the network device,
wherein the second indication information comprises at least one of:
available uplink and downlink configuration information of the terminal, in a case of ensuring compliance with applicable electromagnetic power density exposure requirement or the electromagnetic radiation specific absorption ratio requirement limit;
at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal to ensure compliance with applicable electromagnetic power density exposure requirement or the electromagnetic radiation specific absorption ratio requirement limit in the first time window;
in a case that the current uplink and downlink configuration of the network device is applied, a maximum available output power configurable by the terminal in a case of ensuring compliance with applicable electromagnetic power density exposure requirement or the electromagnetic radiation specific absorption ratio requirement limit;
first power class information of the terminal at a first working frequency band where the network device works; and
maximum available output powers configurable by the terminal corresponding to different uplink and downlink configurations, in the case that the applicable electromagnetic power density exposure requirement or the electromagnetic radiation specific absorption ratio requirement limit is met;
wherein the method further comprises:
prior to reporting the second indication information to the network device, sending, to the network device, second power class information of the terminal at the first working frequency band where the network device works;
wherein a transmitting power corresponding to the second power class information is larger than a transmitting power corresponding to the first power class information.

18.-20. (canceled)

21. The method according to claim 12, further comprising:
determining, according to the first indication information, at least one of:
in a case of ensuring compliance with applicable electromagnetic power density exposure requirement or the electromagnetic radiation specific absorption ratio requirement limit, at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal;
in a case that the current uplink and downlink configuration of the network device is applied, a maximum available output power configurable by the terminal in a case of ensuring compliance with applicable electromagnetic power density exposure requirement or the electromagnetic radiation specific absorption ratio requirement limit; and
the maximum available output powers configurable by the terminal in different uplink and downlink configurations, in the case that the applicable electromagnetic power density exposure requirement or the electromagnetic radiation specific absorption ratio requirement limit is met;
wherein the method further comprises:
reconfiguring a maximum available output power of the terminal, or controlling the terminal to perform a power back-off, or prohibiting a transmission of at least one piece of uplink information of the terminal; wherein the uplink information comprises: an uplink slot, or an uplink sub-frame, or an uplink symbol;
wherein the prohibiting the transmission of the at least one piece of uplink information of the terminal comprises:
in a case of ensuring compliance with applicable electromagnetic power density exposure requirement or the electromagnetic radiation specific absorption ratio requirement limit, determining, according to the first indication information, at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal;
in a case that an uplink duration scheduled by the network device for the terminal is greater than the maximum uplink duration capable of being scheduled or transmitted of the terminal or in a case that an uplink duration percentage scheduled by the network device for the terminal is greater than the maximum percentage of uplink duration capable of being scheduled or transmitted of the terminal, prohibiting a data transmission on at least one uplink time unit; or
in a case that a resource quantity of uplink slots scheduled by the network device for the terminal is greater than a maximum resource quantity of uplink slots capable of being scheduled or transmitted of the terminal or in a case that an uplink slot percentage scheduled by the network device for the terminal is greater than the maximum percentage of uplink slot capable of being scheduled or transmitted of the terminal, prohibiting a data transmission on a resource of at least one uplink slot; or
in a case that a resource quantity of uplink sub-frames scheduled by the network device for the terminal is greater than the maximum quantity of uplink sub-frames capable of being scheduled or transmitted of the terminal or in a case that an uplink sub-frame percentage scheduled by the network device for the terminal is greater than the maximum percentage of uplink sub-frame capable of being scheduled or transmitted of the terminal, prohibiting a data transmission on a resource of at least one uplink sub-frame; or
in a case that a resource quantity of uplink symbols scheduled by the network device for the terminal is greater than the maximum quantity of uplink symbols capable of being scheduled or transmitted of the terminal or in a case that an uplink symbol percentage scheduled by the network device for the terminal is greater than the maximum percentage of uplink symbol capable of being scheduled or transmitted of the terminal, prohibiting a data transmission on a resource of at least one uplink symbol.

22.-25. (canceled)

26. The method according to claim 12, further comprising:
in a case that a duration of scheduled or transmitted resource of the terminal is greater than the maximum uplink duration capable of being scheduled or transmitted of the terminal in the first time window, reconfiguring, by the terminal, a maximum available output power of the terminal or performing a power back-off by the terminal; or
in a case that a quantity of slots of scheduled or transmitted resource of the terminal is greater than the maximum quantity of uplink slots capable of being scheduled or transmitted of the terminal in the first time window, reconfiguring, by the terminal, a maximum available output power of the terminal or performing a power back-off by the terminal; or
in a case that a quantity of uplink sub-frames of scheduled or transmitted resource of the terminal is greater than the maximum quantity of uplink sub-frames capable of being scheduled or transmitted of the terminal in the first time window, reconfiguring, by the terminal, a maximum available output power of the terminal or performing a power back-off by the terminal; or
in a case that a quantity of uplink symbols of scheduled or transmitted resource of the terminal is greater than the maximum quantity of uplink symbols capable of being scheduled or transmitted of the terminal in the first time window, reconfiguring, by the terminal, a maximum available output power of the terminal or performing a power back-off by the terminal; or
in a case that an uplink duration percentage of scheduled or transmitted resource of the terminal is greater than the maximum percentage of uplink duration capable of being scheduled or transmitted of the terminal in the first time window, reconfiguring, by the terminal, a maximum available output power of the terminal or performing a power back-off by the terminal; or
in a case that an uplink slot percentage of scheduled or transmitted resource of the terminal is greater than the maximum percentage of uplink slot capable of being scheduled or transmitted of the terminal in the first time window, reconfiguring, by the terminal, a maximum available output power of the terminal or performing a power back-off by the terminal; or
in a case that an uplink sub-frame percentage of scheduled or transmitted resource of the terminal is greater than the maximum percentage of uplink sub-frame capable of being scheduled or transmitted of the terminal in the first time window, reconfiguring, by the terminal, a maximum available output power of the terminal or performing a power back-off by the terminal; or
in a case that an uplink symbol percentage of scheduled or transmitted resource of the terminal is greater than the maximum percentage of uplink symbol capable of being scheduled or transmitted of the terminal in the first time window, reconfiguring, by the terminal, a maximum available output power of the terminal or performing a power back-off by the terminal;
wherein the method further comprises:
reporting a reconfigured maximum available output power of the terminal to the network device; or
in a case that scheduled uplink resource of the terminal in the first time window exceeds a first threshold, after the terminal performs the power back-off, a power value of the terminal is less than or equal to a maximum available output power configurable by the terminal.

27.-28. (canceled)

29. The method according to claim 12, further comprising:
in a case that the uplink symbol percentage scheduled or transmitted of the terminal in the first time window is greater than a capability of the terminal corresponding to the second indication information, applying all requirements for the first power class to the supported power class;
or,
the method further comprises:
in a case that the uplink symbol percentage scheduled or transmitted of the terminal in the first time window is greater than a capability of the terminal corresponding to the second indication information, lowering a lower limit of a maximum transmitting power configuration value of the terminal.

30. (canceled)

31. An information transmission method, applied to a terminal, comprising: sending second indication information to a network device,
wherein the second indication information comprises at least one of:
available uplink and downlink configuration information of the terminal, in a case of ensuring compliance with applicable electromagnetic power density exposure requirement or the electromagnetic radiation specific absorption ratio requirement limit;
in a case of ensuring compliance with applicable electromagnetic power density exposure requirement or the electromagnetic radiation specific absorption ratio requirement limit, at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window;
in a case that the current uplink and downlink configuration of the network device is applied, a maximum available output power configurable by the terminal in a case of ensuring compliance with applicable electromagnetic power density exposure requirement or the electromagnetic radiation specific absorption ratio requirement limit;
first power class information of the terminal at a first working frequency band where the network device works; and
the maximum available output powers configurable by the terminal corresponding to different uplink and downlink configurations, in the case that the applicable electromagnetic power density exposure requirement or the electromagnetic radiation specific absorption ratio requirement limit is met.

32. The method according to claim 31, wherein
the first time window comprises at least one frame structure period; or
the first time window comprises at least one slot; or
the first time window comprises at least one sub-frame; or,
the first time window comprises at least one symbol; or
the first time window comprises at least one millisecond.

33. The method according to claim 31, wherein
the first time window is a predefined evaluation period;
the first time window is a time range for the terminal to evaluate whether the applicable electromagnetic power density exposure requirement or the electromagnetic radiation specific absorption ratio requirement limit is met; or
the first time window is a time range of a maximum available uplink resource of the terminal in a case that the terminal evaluates that the applicable electromagnetic power density exposure requirement or the electromagnetic radiation specific absorption ratio requirement limit is met; or
the first time window is a time range of a maximum available output power configurable by the terminal in the case that the terminal evaluates that the applicable electromagnetic power density exposure requirement or the electromagnetic radiation specific absorption ratio requirement limit is met.

34. The method according to claim 31, further comprising:
prior to sending the second indication information to the network device, sending, to the network device, second power class information of the terminal at the first working frequency band where the network device works;
wherein a transmitting power corresponding to the second power class information is larger than a transmitting power corresponding to the first power class information.

35.-36. (canceled)

37. The method according to claim 31, further comprising:
in a case that the uplink symbol percentage scheduled or transmitted of the terminal in the first time window is greater than a capability of the terminal corresponding to the second indication information, applying all requirements for the first power class to the supported power class;
or,
the method further comprises:
in a case that the uplink symbol percentage scheduled or transmitted of the terminal in the first time window is greater than a capability of the terminal corresponding to the second indication information, lowering a lower limit of a maximum transmitting power configuration value of the terminal.

38. (canceled)

39. An information transmission method, applied to a network device, comprising:
receiving second indication information sent by a terminal,
wherein the second indication information comprises at least one of:
available uplink and downlink configuration information of the terminal, in a case of ensuring compliance with applicable electromagnetic power density exposure requirement or the electromagnetic radiation specific absorption ratio requirement limit;
in a case of ensuring compliance with applicable electromagnetic power density exposure requirement or the electromagnetic radiation specific absorption ratio requirement limit, at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window;
in a case that the current uplink and downlink configuration of the network device is applied, a maximum available output power configurable by the terminal in a case of ensuring compliance with applicable electromagnetic power density exposure requirement or the electromagnetic radiation specific absorption ratio requirement limit;
first power class information of the terminal at a first working frequency band where the network device works; and
the maximum available output powers configurable by the terminal corresponding to different uplink and downlink configurations, in the case that the applicable electromagnetic power density exposure requirement or the electromagnetic radiation specific absorption ratio requirement limit is met.

40. The method according to claim 39, wherein
the first time window comprises at least one frame structure period; or
the first time window comprises at least one slot; or
the first time window comprises at least one sub-frame; or,
the first time window comprises at least one symbol; or
the first time window comprises at least one millisecond.

41. The method according to claim 39, wherein the first time window is a predefined evaluation period;
the first time window is a time range for the terminal to evaluate whether the applicable electromagnetic power density exposure requirement or the electromagnetic radiation specific absorption ratio requirement limit is met; or
the first time window is a time range of a maximum available uplink resource of the terminal in a case that the terminal evaluates that the applicable electromagnetic power density exposure requirement or the electromagnetic radiation specific absorption ratio requirement limit is met; or
the first time window is a time range of a maximum available output power configurable by the terminal in the case that the terminal evaluates that the applicable electromagnetic power density exposure requirement or the electromagnetic radiation specific absorption ratio requirement limit is met.

42. The method according to claim 39, further comprising:
prior to receiving the second indication information sent by the terminal, receiving second power class information of the terminal at the first working frequency band where the network device works which is sent by the terminal;
wherein a transmitting power corresponding to the second power class information is larger than a transmitting power corresponding to the first power class information.

43.-44. (canceled)

45. The method according to claim 39, further comprising:
the network device performing an uplink resource scheduling or an uplink transmission for the terminal;
a duration of scheduled or transmitted resource is less than or equal to the maximum uplink duration capable of being scheduled or transmitted of the terminal in the first time window; or
a quantity of slots of scheduled or transmitted resource is less than or equal to the maximum quantity of uplink slots capable of being scheduled or transmitted of the terminal in the first time window; or
a quantity of uplink sub-frames of scheduled or transmitted resource is less than or equal to the maximum quantity of uplink sub-frames capable of being scheduled or transmitted of the terminal in the first time window; or
a quantity of uplink symbols of scheduled or transmitted resource is less than or equal to the maximum quantity of uplink symbols capable of being scheduled or transmitted of the terminal in the first time window; or
an uplink duration percentage of scheduled or transmitted resource is less than or equal to the maximum percentage of uplink duration capable of being scheduled or transmitted of the terminal in the first time window; or
an uplink slot percentage of scheduled or transmitted resource is less than or equal to the maximum percentage of uplink slot capable of being scheduled or transmitted of the terminal in the first time window; or
an uplink sub-frame percentage of scheduled or transmitted resource is less than or equal to the maximum percentage of uplink sub-frame capable of being scheduled or transmitted of the terminal in the first time window; or
an uplink symbol percentage of scheduled or transmitted resource is less than or equal to the maximum percentage of uplink symbol capable of being scheduled or transmitted of the terminal in the first time window;
or,
the method further comprises:
sending, by the network device, a power adjustment value to the terminal; wherein
in a case that the power adjustment value is applied to the terminal, a transmitting power of the terminal is less than or equal to a maximum available output power configurable by the terminal; or
in the case that the power adjustment value is applied to the terminal, the transmitting power of the terminal is less than or equal to a transmitting power value corresponding to a first power class of the terminal at a first working frequency band; or
in the case that the power adjustment value is applied to the terminal, the transmitting power of the terminal is less than or equal to the maximum available output power configurable by the terminal in a case that the current uplink and downlink configuration of the network device is applied.

46. (canceled)

47. A network device, comprising a processor and a transceiver, wherein the processor is configured to control the transceiver to:
send first indication information to a terminal, wherein the first indication information comprises at least one of:
location area identity information of the network device;
information of current uplink and downlink configuration of the network device;
specific absorption ratio limit information, comprising: an applicable electromagnetic power density exposure requirement, an electromagnetic radiation specific absorption ratio requirement limit, an applicable electromagnetic power density exposure requirement identity or an electromagnetic radiation specific absorption ratio requirement limit identity;
uplink resource control information, comprising at least one of: a quantity of uplink time domain resources, a quantity of uplink symbols, a quantity of uplink slots, an uplink symbol duty ratio, an uplink slot duty ratio, a maximum quantity of available uplink time domain resources of the terminal, a maximum quantity of available uplink symbols of the terminal, a maximum quantity of available uplink slots of the terminal, a maximum available uplink symbol duty ratio of the terminal, a maximum uplink slot duty ratio of the terminal, a maximum quantity of uplink time domain resources capable of being scheduled or transmitted of the terminal, a maximum quantity of uplink symbols capable of being scheduled or transmitted of the terminal, a maximum quantity of uplink slots capable of being scheduled or transmitted of the terminal, a maximum percentage of uplink duration capable of being scheduled or transmitted of the terminal, a maximum percentage of uplink slot capable of being scheduled or transmitted of the terminal, a maximum percentage of uplink sub-frame capable of being scheduled or transmitted of the terminal and a maximum percentage of uplink symbol capable of being scheduled or transmitted of the terminal in the first time window; and
first time window configuration information configured to indicate a duration of a first time window.

48.-51. (canceled)

52. The network device according to claim 47, wherein the transceiver is further configured to acquire second indication information reported by the terminal,
wherein the second indication information comprises at least one of:
available uplink and downlink configuration information of the terminal, in a case of ensuring compliance with applicable electromagnetic power density exposure requirement or the electromagnetic radiation specific absorption ratio requirement limit;
in a case of ensuring compliance with applicable electromagnetic power density exposure requirement or the electromagnetic radiation specific absorption ratio requirement limit, at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window;
in a case that the current uplink and downlink configuration of the network device is applied, a maximum available output power configurable by the terminal in a case of ensuring compliance with applicable electromagnetic power density exposure requirement or the electromagnetic radiation specific absorption ratio requirement limit;
first power class information of the terminal at a first working frequency band where the network device works; and
the maximum available output powers configurable by the terminal corresponding to different uplink and downlink configurations, in the case that the applicable electromagnetic power density exposure requirement or the electromagnetic radiation specific absorption ratio requirement limit is met.

53. The network device according to claim 52, wherein the transceiver is further configured to: prior to acquiring the second indication information, acquire second power class information of the terminal at the first working frequency band where the network device works;
wherein a transmitting power corresponding to the second power class information is larger than a transmitting power corresponding to the first power class information;
or,
the processor is further configured to:
determine the maximum available output power configurable by the terminal in the first time window, according to the second indication information reported by the terminal; or
determine the first power class information of the terminal at a first working frequency band where the network device works, according to the second indication information reported by the terminal; or
determine, according to the second indication information reported by the terminal, at least one of the maximum uplink duration capable of being scheduled or transmitted of the terminal, the maximum quantity of uplink slots capable of being scheduled or transmitted of the terminal, the maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window.

54.-55. (canceled)

56. The network device according to claim 47, wherein the processor is further configured to:
perform an uplink resource scheduling or uplink transmission for the terminal;
wherein a duration of scheduled or transmitted resource is less than or equal to a maximum uplink duration capable of being scheduled or transmitted of the terminal; or
a quantity of slots of the scheduled or transmitted resource is less than or equal to a maximum quantity of uplink slots capable of being scheduled or transmitted of the terminal; or
a quantity of uplink sub-frames of the scheduled or transmitted resource is less than or equal to a maximum quantity of uplink sub-frames capable of being scheduled or transmitted of the terminal; or
a quantity of uplink symbols of the scheduled or transmitted resource is less than or equal to a maximum quantity of uplink symbols capable of being scheduled or transmitted of the terminal; or
an uplink duration percentage of the scheduled or transmitted resource is less than or equal to a maximum percentage of uplink duration capable of being scheduled or transmitted of the terminal; or
an uplink slot percentage of the scheduled or transmitted resource is less than or equal to a maximum percentage of uplink slot capable of being scheduled or transmitted of the terminal; or
an uplink sub-frame percentage of the scheduled or transmitted resource is less than or equal to a maximum percentage of uplink sub-frame capable of being scheduled or transmitted of the terminal; or
an uplink symbol percentage of the scheduled or transmitted resource is less than or equal to a maximum percentage of uplink symbol capable of being scheduled or transmitted of the terminal.

57. The network device according to claim 47, wherein the processor is further configured to:
send a power adjustment value to the terminal; wherein
in a case that the power adjustment value is applied to the terminal, a transmitting power of the terminal is less than or equal to a maximum available output power configurable by the terminal; or
in the case that the power adjustment value is applied to the terminal, the transmitting power of the terminal is less than or equal to a transmitting power value corresponding to a first power class of the terminal at a first working frequency band; or
in the case that the power adjustment value is applied to the terminal, the transmitting power of the terminal is less than or equal to the maximum available output power configurable by the terminal in a case that the current uplink and downlink configuration of the network device is applied.

58. (canceled)

59. A terminal, comprising a processor and a transceiver, wherein the processor is configured to control the transceiver to:
receive first indication information sent by a network device, wherein the first indication information comprises at least one of:
location area identity information of the network device;
information of current uplink and downlink configuration of the network device;
specific absorption ratio limit information, comprising: an applicable electromagnetic power density exposure requirement, an electromagnetic radiation specific absorption ratio requirement limit, an applicable electromagnetic power density exposure requirement identity or an electromagnetic radiation specific absorption ratio requirement limit identity;
uplink resource control information, comprising at least one of: a quantity of uplink time domain resources, a quantity of uplink symbols, a quantity of uplink slots, an uplink symbol duty ratio, an uplink slot duty ratio, a maximum quantity of available uplink time domain resources of the terminal, a maximum quantity of available uplink symbols of the terminal, a maximum quantity of available uplink slots of the terminal, a maximum available uplink symbol duty ratio of the terminal, a maximum uplink slot duty ratio of the terminal, a maximum quantity of uplink time domain resources capable of being scheduled or transmitted of the terminal, a maximum quantity of uplink symbols capable of being scheduled or transmitted of the terminal, a maximum quantity of uplink slots capable of being scheduled or transmitted of the terminal, a maximum percentage of uplink duration capable of being scheduled or transmitted of the terminal, a maximum percentage of uplink slot capable of being scheduled or transmitted of the terminal, a maximum percentage of uplink sub-frame capable of being scheduled or transmitted of the terminal and a maximum percentage of uplink symbol capable of being scheduled or transmitted of the terminal in the first time window; and
first time window configuration information configured to indicate a duration of a first time window.

60.-63. (canceled)

64. The terminal according to claim 59, wherein the processor is further configured to:
control the transceiver to report second indication information to the network device,
wherein the second indication information comprises at least one of:
available uplink and downlink configuration information of the terminal, in a case of ensuring compliance with applicable electromagnetic power density exposure requirement or the electromagnetic radiation specific absorption ratio requirement limit;
at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window;
in a case that the current uplink and downlink configuration of the network device is applied, a maximum available output power configurable by the terminal in a case of ensuring compliance with applicable electromagnetic power density exposure requirement or the electromagnetic radiation specific absorption ratio requirement limit;
first power class information of the terminal at a first working frequency band where the network device works; and
maximum available output powers configurable by the terminal corresponding to different uplink and downlink configurations, in the case that the applicable electromagnetic power density exposure requirement or the electromagnetic radiation specific absorption ratio requirement limit is met;
wherein the transceiver is further configured to:
prior to reporting the second indication information to the network device, send, to the network device, second power class information of the terminal at the first working frequency band where the network device works;
wherein a transmitting power corresponding to the second power class information is larger than a transmitting power corresponding to the first power class information.

65. (canceled)

66. The terminal according to claim 59, wherein in a case that the first indication information comprises the location area identity information of the network device, the processor is further configured to:
determine, according to a country identity in the location area identity information of the network device, a country where the network device is located, and acquire the applicable electromagnetic power density exposure requirement or the electromagnetic radiation specific absorption ratio requirement limit corresponding to the country; or
determine, according to a country identity and an operator identity in the location area identity information of the network device, a country and an operator where the network device is located, and acquire the applicable electromagnetic power density exposure requirement or the electromagnetic radiation specific absorption ratio requirement limit corresponding to the country and the operator.

67. (canceled)

68. The terminal according to claim 59, wherein the processor is further configured to:
determine, according to the first indication information, at least one of:
in a case of ensuring compliance with applicable electromagnetic power density exposure requirement or the electromagnetic radiation specific absorption ratio requirement limit, at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal;
in a case that the current uplink and downlink configuration of the network device is applied, a maximum available output power configurable by the terminal in a case of ensuring compliance with applicable electromagnetic power density exposure requirement or the electromagnetic radiation specific absorption ratio requirement limit; and
the maximum available output powers configurable by the terminal in different uplink and downlink configurations, in the case that the applicable electromagnetic power density exposure requirement or the electromagnetic radiation specific absorption ratio requirement limit is met.

69.-72. (canceled)

73. The terminal according to claim 59, wherein the processor is further configured to:
in a case that a duration of scheduled or transmitted resource of the terminal is greater than the maximum uplink duration capable of being scheduled or transmitted of the terminal in the first time window, reconfigure a maximum available output power of the terminal or performing a power back-off by the terminal; or
in a case that a quantity of slots of scheduled or transmitted resource of the terminal is greater than the maximum quantity of uplink slots capable of being scheduled or transmitted of the terminal in the first time window, reconfigure a maximum available output power of the terminal or performing a power back-off by the terminal; or
in a case that a quantity of uplink sub-frames of scheduled or transmitted resource of the terminal is greater than the maximum quantity of uplink sub-frames capable of being scheduled or transmitted of the terminal in the first time window, reconfigure a maximum available output power of the terminal or performing a power back-off by the terminal; or
in a case that a quantity of uplink symbols of scheduled or transmitted resource of the terminal is greater than the maximum quantity of uplink symbols capable of being scheduled or transmitted of the terminal in the first time window, reconfigure a maximum available output power of the terminal or performing a power back-off by the terminal; or
in a case that an uplink duration percentage of scheduled or transmitted resource of the terminal is greater than the maximum percentage of uplink duration capable of being scheduled or transmitted of the terminal in the first time window, reconfigure a maximum available output power of the terminal or performing a power back-off by the terminal; or
in a case that an uplink slot percentage of scheduled or transmitted resource of the terminal is greater than the maximum percentage of uplink slot capable of being scheduled or transmitted of the terminal in the first time window, reconfigure a maximum available output power of the terminal or performing a power back-off by the terminal; or
in a case that an uplink sub-frame percentage of scheduled or transmitted resource of the terminal is greater than the maximum percentage of uplink sub-frame capable of being scheduled or transmitted of the terminal in the first time window, reconfigure a maximum available output power of the terminal or performing a power back-off by the terminal; or
in a case that an uplink symbol percentage of scheduled or transmitted resource of the terminal is greater than the maximum percentage of uplink symbol capable of being scheduled or transmitted of the terminal in the first time window, reconfigure a maximum available output power of the terminal or performing a power back-off by the terminal.

74.-75. (canceled)

76. The terminal according to claim 59, wherein the processor is further configured to:
in a case that an uplink symbol percentage scheduled or transmitted by the terminal in the first time window is greater than a capability of the terminal corresponding to the second indication information, apply all requirements for the first power class to the supported power class;
or,
the processor is further configured to:
in a case that an uplink symbol percentage scheduled or transmitted by the terminal in the first time window is greater than a capability of the terminal corresponding to the second indication information, lower a lower limit of a maximum transmitting power configuration value of the terminal.

77.-78. (canceled)

79. A terminal, comprising a processor and a transceiver, wherein the processor is configured to control the transceiver to:
send second indication information to a network device,
wherein the second indication information comprises at least one of:
available uplink and downlink configuration information of the terminal, in a case of ensuring compliance with applicable electromagnetic power density exposure requirement or the electromagnetic radiation specific absorption ratio requirement limit;
in a case of ensuring compliance with applicable electromagnetic power density exposure requirement or the electromagnetic radiation specific absorption ratio requirement limit, at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window;
in a case that the current uplink and downlink configuration of the network device is applied, a maximum available output power configurable by the terminal in a case of ensuring compliance with applicable electromagnetic power density exposure requirement or the electromagnetic radiation specific absorption ratio requirement limit;
first power class information of the terminal at a first working frequency band where the network device works; and
the maximum available output powers configurable by the terminal corresponding to different uplink and downlink configurations, in the case that the applicable electromagnetic power density exposure requirement or the electromagnetic radiation specific absorption ratio requirement limit is met.

80. (canceled)

81. The terminal according to claim 79, wherein
the first time window is a predefined evaluation period;
the first time window is a time range for the terminal to evaluate whether the applicable electromagnetic power density exposure requirement or the electromagnetic radiation specific absorption ratio requirement limit is met; or
the first time window is a time range of a maximum available uplink resource of the terminal in a case that the terminal evaluates that the applicable electromagnetic power density exposure requirement or the electromagnetic radiation specific absorption ratio requirement limit is met; or
the first time window is a time range of a maximum available output power configurable by the terminal in the case that the terminal evaluates that the applicable electromagnetic power density exposure requirement or the electromagnetic radiation specific absorption ratio requirement limit is met.

82. The terminal according to claim 79, wherein the transceiver is further configured to:
prior to sending the second indication information to the network device, send, to the network device, second power class information of the terminal at the first working frequency band where the network device works;
wherein a transmitting power corresponding to the second power class information is larger than a transmitting power corresponding to the first power class information.

83.-84. (canceled)

85. The terminal according to claim 79, wherein the processor is further configured to:
in a case that an uplink symbol percentage scheduled or transmitted by the terminal in the first time window is greater than a capability of the terminal corresponding to the second indication information, apply all requirements for the first power class to the supported power class;
or,
the processor is further configured to:
in a case that an uplink symbol percentage scheduled or transmitted by the terminal in the first time window is greater than a capability of the terminal corresponding to the second indication information, lower a lower limit of a maximum transmitting power configuration value of the terminal.

86.-87. (canceled)

88. A network device, comprising a processor and a transceiver, wherein the processor is configured to control the transceiver to:
receive second indication information sent by a terminal,
wherein the second indication information comprises at least one of:
available uplink and downlink configuration information of the terminal, in a case of ensuring compliance with applicable electromagnetic power density exposure requirement or the electromagnetic radiation specific absorption ratio requirement limit;
in a case of ensuring compliance with applicable electromagnetic power density exposure requirement or the electromagnetic radiation specific absorption ratio requirement limit, at least one of the available uplink and downlink configuration information of the terminal, a maximum uplink duration capable of being scheduled or transmitted of the terminal, the maximum quantity of uplink slots capable of being scheduled or transmitted of the terminal, a maximum quantity of uplink sub-frames capable of being scheduled or transmitted of the terminal, the maximum quantity of uplink symbols capable of being scheduled or transmitted of the terminal, the maximum percentage of uplink duration capable of being scheduled or transmitted of the terminal, the maximum percentage of uplink slot capable of being scheduled or transmitted of the terminal, the maximum percentage of uplink sub-frame capable of being scheduled or transmitted of the terminal and the maximum percentage of uplink symbol capable of being scheduled or transmitted of the terminal in the first time window;
in a case that the current uplink and downlink configuration of the network device is applied, a maximum available output power configurable by the terminal in a case of ensuring compliance with applicable electromagnetic power density exposure requirement or the electromagnetic radiation specific absorption ratio requirement limit;
first power class information of the terminal at a first working frequency band where the network device works; and
the maximum available output powers configurable by the terminal corresponding to different uplink and downlink configurations, in the case that the applicable electromagnetic power density exposure requirement or the electromagnetic radiation specific absorption ratio requirement limit is met.

89. (canceled)

90. The network device according to claim 88, wherein the first time window is a predefined evaluation period;
the first time window is a time range for the terminal to evaluate whether the applicable electromagnetic power density exposure requirement or the electromagnetic radiation specific absorption ratio requirement limit is met; or
the first time window is a time range of a maximum available uplink resource of the terminal in a case that the terminal evaluates that the applicable electromagnetic power density exposure requirement or the electromagnetic radiation specific absorption ratio requirement limit is met; or
the first time window is a time range of a maximum available output power configurable by the terminal in the case that the terminal evaluates that the applicable electromagnetic power density exposure requirement or the electromagnetic radiation specific absorption ratio requirement limit is met.

91. The network device according to claim 88, wherein the transceiver is further configured to:
prior to receiving the second indication information sent by the terminal, receive second power class information of the terminal at the first working frequency band where the network device works which is sent by the terminal;
wherein a transmitting power corresponding to the second power class information is larger than a transmitting power corresponding to the first power class information.

92.-93. (canceled)

94. The network device according to claim 88, wherein the processor is further configured to:
perform an uplink resource scheduling or an uplink transmission for the terminal;
a duration of scheduled or transmitted resource is less than or equal to the maximum uplink duration capable of being scheduled or transmitted of the terminal in the first time window; or
a quantity of slots of scheduled or transmitted resource is less than or equal to the maximum quantity of uplink slots capable of being scheduled or transmitted of the terminal in the first time window; or
a quantity of uplink sub-frames of scheduled or transmitted resource is less than or equal to the maximum quantity of uplink sub-frames capable of being scheduled or transmitted of the terminal in the first time window; or
a quantity of uplink symbols of scheduled or transmitted resource is less than or equal to the maximum quantity of uplink symbols capable of being scheduled or transmitted of the terminal in the first time window; or
an uplink duration percentage of scheduled or transmitted resource is less than or equal to the maximum percentage of uplink duration capable of being scheduled or transmitted of the terminal in the first time window; or
an uplink slot percentage of scheduled or transmitted resource is less than or equal to the maximum percentage of uplink slot capable of being scheduled or transmitted of the terminal in the first time window; or
an uplink sub-frame percentage of scheduled or transmitted resource is less than or equal to the maximum percentage of uplink sub-frame capable of being scheduled or transmitted of the terminal in the first time window; or
an uplink symbol percentage of scheduled or transmitted resource is less than or equal to the maximum percentage of uplink symbol capable of being scheduled or transmitted of the terminal in the first time window;
or,
the processor is further configured to:
send a power adjustment value to the terminal; wherein
in a case that the power adjustment value is applied to the terminal, a transmitting power of the terminal is less than or equal to a maximum available output power configurable by the terminal; or
in the case that the power adjustment value is applied to the terminal, the transmitting power of the terminal is less than or equal to a transmitting power value corresponding to a first power class of the terminal at a first working frequency band; or
in the case that the power adjustment value is applied to the terminal, the transmitting power of the terminal is less than or equal to the maximum available output power configurable by the terminal in a case that the current uplink and downlink configuration of the network device is applied.

95.-96. (canceled)

97. A computer-readable storage medium, wherein a computer program is stored in the computer-readable storage medium, a processor executes the program to perform the information transmission method applied to the network device according to claim 1.
